(19) United States
(12) Patent Application Publication
(10) Pub. No.: US 2015/0102208 A1
(43) Pub. Date: Apr. 16, 2015

(54) WEARABLE SYSTEM AND METHOD TO MEASURE AND MONITOR ULTRAVIOLET, VISIBLE LIGHT, AND INFRARED RADIATIONS IN ORDER TO PROVIDE PERSONALIZED MEDICAL RECOMMENDATIONS, PREVENT DISEASES, AND IMPROVE DISEASE MANAGEMENT

(71) Applicant: The Joan & Irwin Jacobs Technion-Cornell Innovation Institute (JACOBS INSTITUTE), New York, NY (US)

(72) Inventors: Geoffrey Appelboom, New York, NY (US); Emmanuel Dumont, New York, NY (US)

(21) Appl. No.: 14/504,185

(22) Filed: Oct. 1, 2014

Related U.S. Application Data
(60) Provisional application No. 61/886,003, filed on Oct. 2, 2013.

(51) Int. Cl. G01J 1/42

(52) U.S. Cl. CPC G01J 1/4204; G01J 1/4228; G01J 2001/4266
USPC 250/208.2

(57) ABSTRACT

A wearable sensor device, system, and methods for electronically monitoring safe ultraviolet and infrared radiations and beneficial visible light exposure based on sensor data and clinical information data relevant to estimate a personalized radiation pattern for disease prevention, a personalized radiation pattern for an evolution in disease activity or skin aging from radiation exposure of the user of the wearable sensor device and other users of the wearable sensor device. The wearable sensor device includes one or more UV sensors, an ambient light sensor, one IR sensor, and the wearable sensor device is in communication with remote computing devices to communicate sensor data and to calculate, send, and receive recommendations regarding beneficial radiation exposure and safe UV and IR exposure at the wearable sensor device, or remote computing devices paired with or connected to the wearable sensor device.

### CROSS-REFERENCE TO RELATED APPLICATION

This application claims the benefit of U.S. Provisional Application No. 61/886,003, entitled A Wearable System And Method For Monitoring Light Intensity And Ultraviolet Light Levels, filed Oct. 2, 2013, the entire contents of which are incorporated herein by reference.

### FIELD OF THE INVENTION

This invention relates generally to computer based systems and methods for using sensors to monitor electromagnetic radiations including ultraviolet (UV), visible light, and infrared (IR) radiations, and more specifically to using wearable sensors for medical applications and for personalized monitoring of health and well-being.

### BACKGROUND

Sunlight emits a complex spectrum of electromagnetic radiations and the ones reaching the surface of the earth are ultraviolet (wavelength comprised between 100 nm and 400 nm), visible light (wavelength comprised between 380 nm and 750 nm), and infrared radiations (wavelength comprised between 700 nm and 1 mm). Sunlight is often labeled as something to avoid as it is blamed for causing skin cancer.

While the shorter wavelengths of visible light can only penetrate dermal layers to a depth of 2-3 mm, near infrared light (600-800 nm) penetrates skin for up to 23 cm and can be transcutaneously delivered deep into inner tissues such as muscles and nerve cells. Light in this wavelength range (600-800 nm) has been shown to promote wound healing and human tissue growth. Also, human transcutaneous exposure to infrared light affects the human immune response.

While it is true that overexposure to sunlight can be a contributor to sunburn, melanoma and other skin cancers, a lack of sunlight and illumination is also associated with reduced cognitive function, and can induce depression and related diseases such as chronic pain.

### Sunlight Overexposure

Sunburn is a prevalent side effect of sunlight overexposure. In the United States, the estimated sunburn prevalence among all adults was approximately 34 percent in 2004. Sunburn prevalence ranging from 20 to 70 percent has been reported in cross-sectional studies in Europe and Australia.

Sunburn is an acute, delayed, and transient inflammatory response of the skin to excessive exposure to ultraviolet (UV) radiation from natural sunlight or artificial sources (e.g., tanning beds, phototherapy devices, and the like). While both UVB and UVA radiation can cause sunburn, the wavelengths that are most effective in inducing redness and inflammation of skin (e.g., erythema) are in the UVB range (280 to 320 nm).

UVB radiation is absorbed in the epidermis and superficial dermis by molecules called chromophores, which include DNA, urocanic acid (a breakdown product of histidine abundantly present in stratum corneum), keratin, and melanin. Although nuclear DNA is the main chromophore in the skin, there is evidence that UVB also targets cytoplasm and cell membrane components, including cell surface receptors, kinases, phosphatases, and transcription factors.

Prevention of sun-related skin damage frequently involves sun avoidance, wearing protective clothing, and liberal use of broad spectrum sunscreens. Sunscreens are designed to prevent erythema from acute solar exposure and their efficacy is indicated by their sun protection factor (SPF) that is not necessarily indicative of protection from other types of acute photodamage, let alone chronic photodamage.

Indeed the evidence for a long-term benefit of sunscreen use is somewhat limited with some evidence for protection from squamous cell carcinoma, but none for basal cell carcinoma and malignant melanoma. For example, a sunscreen that protected against erythema but gave a much lower level of protection against immunosuppression could give a false sense of security and actually increase skin cancer risk, because more immunosuppressive damage might be done for a given level of erythema with the sunscreen that the same level of erythema without the sunscreen.

It is thus important that clinicians counsel patients with sun-sensitive skin types and other skin risk factors about sun protection, because sunburn is a marker of genetic susceptibility to skin cancer and is associated with an increased risk of skin cancer at all ages. Recreational sun exposure and sunburn are strong predictors of melanoma at all latitudes, whereas measures of occupational and total sun exposure appear to predict non-melanoma and melanoma skin cancer predominately at low latitudes.

Solar radiation entering the Earth's atmosphere is attenuated by dry air molecules (mainly nitrogen, oxygen, argon, carbon dioxide), water vapor, aerosols (particulate matters). The actual composition and concentration of the constituents vary with geographic location, elevation, and season. As a result, solar irradiation is dependent on geographic location, elevation, season, and human activity.

Photoaging, another effect of sun over exposure, is premature skin aging resulting from prolonged and repeated exposure to radiations. The changes of photodamage are superimposed on the changes caused by chronological aging and are responsible for most of the age-associated features of skin appearance. Photoaging of the skin is primarily triggered by UV and IR radiations. Both types of radiation have been shown to accelerate the degradation of skin connective tissue (e.g., collagen proteins) and thus accelerate visible signs of skin aging.

Photoaging is distinct from normal chronological aging. Clinically, photoaged skin is dry, deeply wrinkled, inelastic, leathery and telangiectatic, often with irregular pigmentation, freckling and lentigo formation. Histologically, such skin shows marked quantitative and qualitative abnormalities, particularly of the dermal connective tissue, including the accumulation of abnormal elastotic material, namely, elastosis, and proteoglycans. Furthermore, the degradation and disorganization of collagen fibrils, responsible for the strength and resilience of skin, have been observed. Chronic exposure to sub-erythemal UVA plays an important role in photoaging. Photosensitivity is an increased sensitivity or abnormal response to UV radiation. The most common manifestation of a photosensitivity is the appearance of lesions of various shapes and sizes on areas of the skin that have been exposed to UV radiation. The time required for such a response to occur can be anywhere from a few minutes of exposure to UV radiation to hours spent exposed to it.

### Visible Light and UV Underexposure

Light exposure has beneficial effects on human health. For instance, bright visible light helps to regulate the hormones serotonin and melatonin. Visible light has also been shown to impact brain blood flow, which has been linked with cognitive functions.

Light therapy and heliotherapy are widely used to treat seasonal affective disorder (SAD), as well as nonseasonal depression and premenstrual dysphoric disorder (PMDD).

There is a paucity of data regarding its use in pregnant and postpartum women. One report of pregnant depressed women and another of postpartum depressed women treated with morning bright light therapy provided preliminary support for the hypothesis that light therapy may have an antidepressant effect in these populations. Furthermore, light therapy may be helpful for depression during pregnancy. One randomized trial compared 7000 lux fluorescent bright white light with 70 lux dim red (placebo) light in 27 pregnant women with non-seasonal unipolar major depression. Remission occurred in significantly more patients who received bright light than placebo (69 versus 36 percent).

UV radiation on the skin triggers the photoisomerization of provitamin D into vitamin D3 (cholecalciferol) in the skin; they are then bound by the vitamin D binding proteins (DBP) and transported via blood to target organs for metabolism and activity. Metabolic activation of vitamin D to calcitriol and its effects on calcium and phosphate homeostasis results in an increase in the serum calcium and phosphate concentrations.

Lack of vitamin D activity leads to reduced intestinal absorption of calcium and phosphorus. Early in vitamin D deficiency, hypophosphatemia is more marked than hypocalcemia. With persistent vitamin D deficiency, hypocalcemia occurs and causes secondary hyperparathyroidism, which leads to phosphaturia, demineralization of bones and, when prolonged, to osteomalacia in adults and rickets in children.

Lack of exposure to bright light may also affect sleep patterns. Exposure to the sun helps the body determine when to release the hormone melatonin. Melatonin helps regulate the body's internal clock by signaling when it is time to go to bed. In a five-day study performed by researchers in New York State, children were given glasses that blocked blue light emitted by sun rays. At the end of the five days, the results showed the children had a delayed release of melatonin of approximately six minutes each day, and went to bed an average of a half an hour later than at the start of the study.

### SUMMARY OF THE INVENTION

The claimed invention provides for a wearable system and methods to measure and monitor ultraviolet radiation, visible light, and infrared radiation in order to provide personalized medical recommendations, prevent diseases and skin aging, and improve disease management. Embodiments of the claimed invention provide for a wearable sensor device, system, and methods for electronically monitoring ultraviolet, visible light, and infrared radiation exposure based on sensor data which, in combination with relevant clinical information data and other users' radiation data and clinical information data, permits the identification of personalized radiation patterns that would put the user of the wearable sensor device at risk for diseases, skin aging, and/or would trigger an evolution in disease activity.

In a first aspect, a wearable sensor device is provided for monitoring ultraviolet (UV) radiation, visible light, and infrared (IR) radiation comprising one or more sensors that measure UV radiation; a visible light sensor; one or more sensors that measure IR radiation; one or more processors; memory; a telemetry unit for communicating data received at the sensors and clinical information data relevant to estimate a personalized evolution in disease activity, skin aging, or risk level from radiation exposure from the memory of the wearable sensor device to a remote computing device connected to or paired with the wearable sensor; and an analog to digital converter.

In one embodiment, one of the sensors that measure UV radiation measures UVB radiation. In another embodiment, one of the sensors that measure UV radiation measure UVA and another sensor measures UVC radiation.

In another embodiment, the telemetry unit further comprises one or more of an antenna or radio frequency (RF) transmitter and wireless transceiver that allows the wearable sensor device to communicate using a wireless connection in the form of a Wi-Fi connection, a Bluetooth connection, a low-energy Bluetooth connection, cellular connection, or any other form of wireless tethering or near field communication.

In another embodiment, the wearable sensor device is further configured and programmed to determine a personalized radiation pattern for an evolution in disease activity, based on the clinical information data of a user of the wearable sensor device and other users of the wearable sensor device, data received from the one or more sensors that measure total UV and IR radiation, and the ambient light intensity sensor, and send an alert to the wearable sensor device or to a remote computing device that is paired with or connected to the wearable sensor device, the alert including apply more sunscreen, total UV exposure, a time remaining for safe UV exposure, and an end time for safe UV exposure.

In another embodiment, the wearable sensor device is further configured and programmed to calculate a personalized radiation pattern for skin aging, risk level from radiation exposure, and personalized radiation pattern for disease prevention, based on the clinical information data of a user of the wearable sensor device and other users of the wearable sensor device, data received from the one or more sensors that measure total UV radiation, and the ambient light intensity sensor.

In another embodiment, the personalized radiation pattern for disease prevention and the personalized radiation pattern for an evolution in disease activity are also calculated from the data received at the UVA sensor, the UVB sensor, and the UVC sensor.

In other embodiments, the wearable sensor device further comprises a wearable magnetic clip, arm-band, eye glasses, or wrist watch.

In another embodiment, the wearable sensor device further comprises a rechargeable battery.

In another embodiment, the rechargeable battery receives and stores light energy or an electrical signal generated from the light energy received from one or more of the sensors.

In another embodiment, the wearable sensor device further comprises an LED and a display screen, wherein the wearable sensor device is in a low power state when the light detector does not detect visible light.

In another embodiment, the wearable sensor device has a housing shaped to permit 360 degree measurement of radiation.

In another embodiment, at least one of the one or more sensors that measure the infrared radiation or the visible light sensor in combination with the LED and the one or more processors are configured to receive the clinical information data from inputs to the wearable sensor device, based on taps or multiple taps of the wearable sensor device surface or the display screen, continuously touching the wearable sensor device surface or the display screen, or based on the distance of a gesture toward the wearable sensor device surface, and store the data inputs in the memory.

In another embodiment, the display screen is a touch sensitive screen.

In another embodiment, the clinical information data includes five or more of age, gender, skin type or tone, amount of body covered with clothing or photo-protective clothing, disease status, skin status, skin conditions, reactions, when sunscreen was last applied, geographic location, and SPF level of sunscreen last applied.

In other embodiments, the clinical information includes current and past medication history, family history of skin sensitivity, tanning bed use, and occupational and recreational activity information.

In other embodiments, he wearable sensor device is further configured and programmed to determine the personalized radiation pattern for an evolution in disease activity, skin aging, and risk level from radiation exposure, based on skin pictures and reported skin symptoms skin pictures, reported skin symptoms, imaging, laboratory tests, or dermatological tests communicated directly via the wearable sensor device or via remote computing device that is paired with or connected to the wearable sensor device.

In another embodiment, the wearable sensor device is further configured and programmed to track time of radiation exposure, total radiation exposure, and issue alerts to apply sunscreen, limit radiation exposure, and end radiation exposure.

In another embodiment, the wearable sensor device is further configured to track a time of beneficial radiation exposure, and issue alerts that include a time for beneficial radiation exposure.

In another embodiment, the wearable sensor device is further configured and programmed to monitor and determine a personalized radiation pattern to prevent seasonal affective disorder (SAD), nonseasonal depression, and premenstrual dysphoric disorder (PMDD), vitamin D deficiency, based on the clinical information data and data received from the total UV sensor or sensors, the UVA sensor, UVB sensor, the visible light intensity sensor, the IR sensor, and send an alert to the wearable sensor device or to a remote computing device that is paired with or connected to the wearable sensor device or a remote computing device paired with or connected to the wearable sensor device, to obtain sun or light exposure and an amount of time for sun or light exposure.

In another aspect, a system for monitoring light intensity and ultraviolet radiation exposure is provided comprising one or more server computers in communication with a wearable sensor device having one or more sensors, said server computers configured and programmed to receive UV radiation, ambient light data and clinical information data relevant to estimate a personalized radiation pattern for an evolution in disease activity, skin aging, or risk level from radiation exposure of a person wearing the wearable sensor device, convert the UV radiation and the ambient light data, and estimate a personalized evolution in disease activity.

In another aspect, a computer based method for monitoring light intensity and ultraviolet radiation exposure is provided comprising receiving at one or more server computers clinical information data relevant to estimate a personalized evolution in disease activity, skin aging, or risk level from radiation exposure of a person using a wearable sensor device, at the wearable sensor device or a remote computing device paired with or connected to the wearable sensor device, the wearable sensor device having one or more UV sensors and an ambient light intensity sensor; storing the clinical information data at the one or more computer servers or on the wearable sensor device; receiving data corresponding to an amount of UV radiation and ambient light exposure of the wearable sensor device and a time of UV exposure; integrating at the wearable sensor device or a remote computing device, including a remote computer server paired or connected with the wearable sensor device, the total UV exposure received at the wearable sensor device over the time of UV exposure; electronically calculating a personalized radiation pattern for an evolution in disease activity, skin aging, and risk level from radiation exposure based on the received data from the one or more UV sensors, and ambient light intensity sensor, and the of the user of the wearable sensor device and other users of the wearable sensor device and determining a time for safe UV exposure; comparing the amount of UV radiation received and the time of UV exposure, and issuing an alert to one or both of the wearable sensor device or a remote computing device paired with or connected to the wearable sensor device; and should providing an alert of a time remaining for safe UV exposure, apply sunscreen or protective outerwear, limit, or stop UV exposure.

In another embodiment, the information data includes five or more of age, gender, skin type or tone, amount of body covered with clothing or photo-protective clothing, disease status, skin status, skin conditions, reactions, when sunscreen was last applied, geographic location, and SPF level of sunscreen last applied.

In another embodiment, the method further comprises the steps of determining a time for beneficial radiation exposure; and issuing an alert on the time remaining for beneficial sun exposure.

In another embodiment, the method further comprises steps of electronically calculating a minimum light exposure to prevent seasonal affective disorder (SAD), nonseasonal depression, and premenstrual dysphoric disorder (PMDD), vitamin D deficiency; and issuing an alert on a time remaining for the minimum light exposure.

In another embodiment, the method further comprises performing a check on the data received from the total UV sensor or sensors by comparing the received data from the total UV sensor or sensors with the data received at a UVA sensor, UVB and UVC sensor.

In another embodiment, the method further comprises receiving additional feedback to update clinical information, including sunscreen application and any symptoms experienced since clinical information data was last reported.

In another embodiment, the method further comprises calculating electronically an appropriate interval for communicating sensor readings from the wearable sensor device to a remote computing device paired with or connected to the wearable sensor device based on the clinical information data.

In another embodiment, the appropriate interval is seconds, minutes, hours, days, or months.

### BRIEF DESCRIPTION OF THE DRAWINGS

FIG. 1 illustrates examples of wearable sensor devices that include wearable sensors (e.g., light intensity and UV sensors), in accordance with some embodiments.

FIG. 2 illustrates an example of an electronic system for the wearable sensors illustrated in FIG. 1, in accordance with some embodiments.

FIG. 3A is a table of exemplary photosensitivity disorders and their clinical features that can be included among clinical information data relevant to estimating a personalized evolution in disease activity or risk level from radiation and analyzed as clinical information relevant to estimate a personalized evolution in disease activity with a connected or paired inventive wearable sensor device.

FIG. 3B is table listing common photosensitizing medications that can be included among clinical information data relevant to estimating a personalized radiation pattern for an evolution in disease activity and analyzed with a connected or paired inventive wearable sensor device.

FIGS. 4A-4J are example software interfaces of a remote computing device paired with or connected to a wearable sensor device for entering clinical information data relevant to estimating a personalized evolution in disease activity or risk level from radiation exposure.

FIGS. 5A-5F are an example software application dashboards for a remote computing device paired with or connected to a wearable sensor device for displaying the amount of UV, visible light or IR radiations received and for receiving personalized recommendations regarding UV, visible light, or IR radiation exposure.

FIG. 6 is a flow diagram of exemplary methods for monitoring UV, visible light, and IR radiations in accordance with different embodiments of wearable sensor devices described herein.

The figures depict various aspects and embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Some embodiments provide a method and system for measuring and analyzing the quantity of electromagnetic radiations, including cumulative UV, visible light, and IR absorbed by an individual over the course of a predetermined interval of time (e.g., a day, a week, a month, and so on) in order to preemptively detect radiations over-exposure (e.g., to prevent sunburn, skin lesions, or any other clinically diagnosed consequence of over-exposure) or radiation under-exposure (e.g., to prevent mood disorders associated with light deprivation). In one embodiment, the system includes a wearable sensor device (e.g., a wearable light sensor) that comprises one or more sensors to measure radiation levels of UV, visible light, and IR incident on the device.

Traditionally, visible light intensity meters have been used for measuring light intensity (usually using the unit of lux) in work places and in photography applications to define positioning of a camera. Various light sensor designs are described in U.S. application Ser. No. 12/742,628 “Light tracking device” filed on Dec. 10, 2008; and U.S. application Ser. No. 12/733,802 “Solar light tracking sensor direction setting/measuring/re-adjusting method and solar light collecting device” filed on Oct. 30, 2008, which are incorporated by reference in their entirety.

Furthermore, UV sensors or detectors are traditionally used for plant and landscape monitoring. Various UV sensor designs are described in U.S. Pub. No. US 20030150998 AI “Device and method for ultraviolet radiation monitoring” filed on Apr. 27, 2001; U.S. application Ser. No. 11/701,052 “Ultraviolet radiation monitoring device and a method of using the same” filed on Feb. 1, 2007; U.S. Pat. No. 6,426,503 B1 “Opto-electronic ultra-violet radiation dosimeter” filed on Jun. 9, 2000; and U.S. application Ser. No. 12/932,575 “Ultraviolet ray measuring apparatus and electronic wristwatch equipped with ultraviolet ray measuring function” filed on Feb. 28, 2011, which are incorporated by reference in their entirety.

In some embodiments, the wearable UV, visible light, and IR radiation sensors are used to measure and monitor the amount of radiations that a person receives in various environments (e.g., indoors in artificial light, indoors in diffused or indirect natural light, outdoors in direct sunlight, in tanning beds, and so on). When implemented in a wearable configuration, such devices can be used in conjunction with clinical information data relevant to estimate a personalized evolution in disease activity, trigger skin aging, or put the user at risk for some diseases. Relevant clinical data include individual skin susceptibility (e.g., skin type, previous known skin pathology, and the like), patient co-morbidities (e.g. depression, vitamin D insufficiency, chronic pain, and so on), and configurable custom settings and/or use preferences based on the user's context (e.g., type of clothing and sun protection being worn, application of sunscreen products, UV index for a given day, and the like) and can be used in ambulatory conditions (e.g., independent of a person's movements and orientation). Other examples of clinical information data clinical information data relevant to estimate a personalized evolution in disease activity, trigger skin aging, or put the user at risk for some diseases are explained in further detail herein.

### Sensor Design

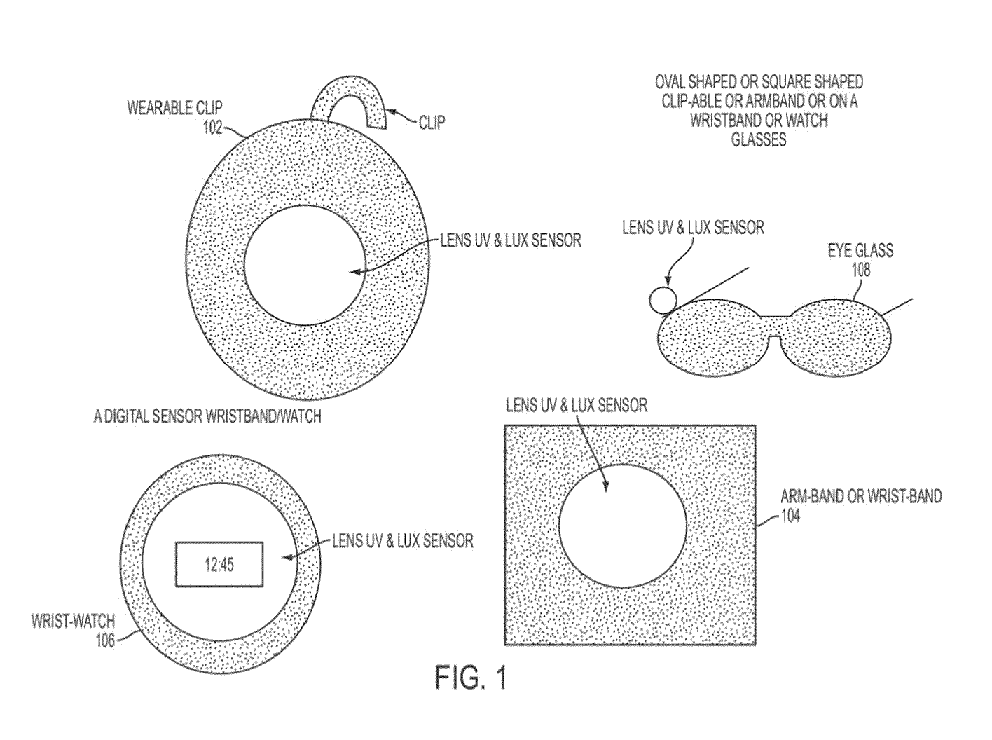

FIG. 1 illustrates examples of wearable sensor devices that include wearable sensors (e.g., UV, visible light, and IR sensors), in accordance with some embodiments. As illustrated in FIG. 1, the wearable sensor device (e.g., comprising the UV, visible light, and IR sensors, and associated focusing lenses) can be designed in various configurations, such as a wearable clip 102, an arm-band or a wrist-band 104, a wrist-watch 106, eye-glass 108, and the like. Other examples include designs incorporated into various forms of jewelry (e.g., necklaces, bracelets, rings, earrings), clipable to a purse or other type of bag, clipable to a belt loop or other clothing item, incorporated into a clothing item (e.g., belt, hat, hair clip), among many other designs.

The wearable clip sensor can be designed as a magnetic clip in which the wearable sensor device contains two pieces that clip together through clothing, for example, based on a thin magnetic surface covering the surface of each part of the two piece wearable sensor device. There can be a concave part of the wearable sensor device and convex shaped part that fit snuggly together, with each part being magnetically attracted to the other. One of the two parts, the top part contains the sensors. The two parts to the wearable sensor device can be attached together with clothing or other worn material, with the clothing or other material sandwiched between them. This flexible magnetic clip structure enables the wearable sensor device to be optimally positioned near skin areas of greater susceptibility to damage.

Such wearable sensor devices can be used to measure, monitor, and evaluate direct absorption (e.g., at the level of the retina or the skin) of the quantity of UV, visible light, and IR radiations a person wearing the device comes across each day. In other words, the wearable sensor device may be used to measure an amount of UV, visible light, and IR radiations in the environments and a duration or time of exposure to these radiations of the person wearing the device. The wearable sensor device can be preferably shaped to allow up to 360 degrees of radiation to penetrate the sensors inside the housing. The wearable sensor devices also should preferably be coated with a material that permits radiations to penetrate the wearable sensor device housing and be measured accurately.

### System Architecture

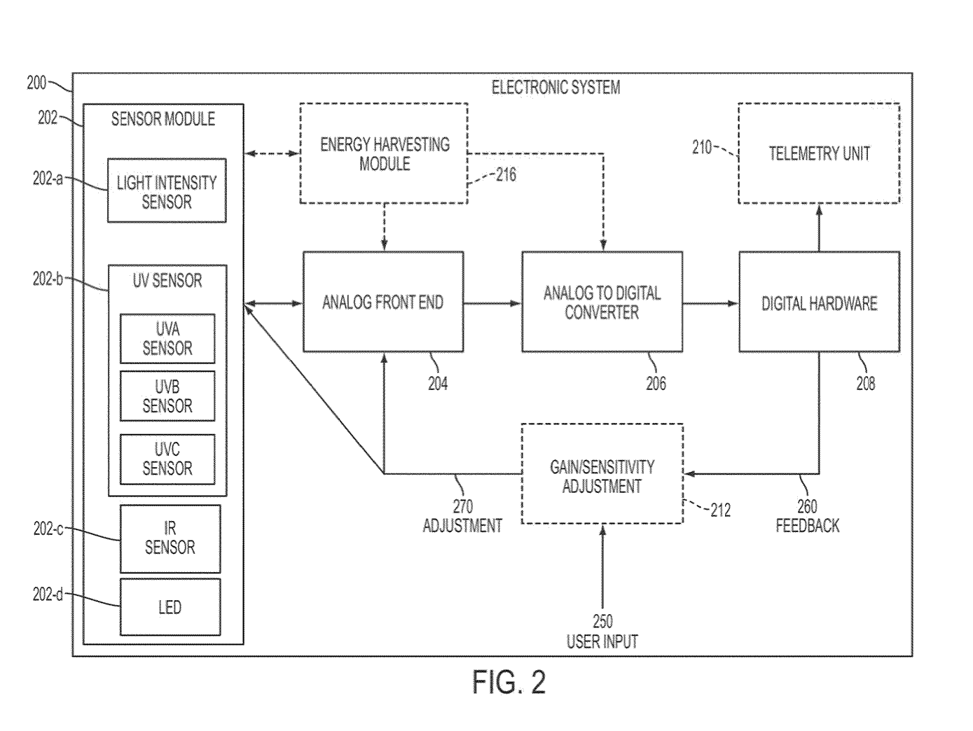

FIG. 2 illustrates an example of an electronic system 200 for the wearable sensor devices illustrated in FIG. 1, in accordance with some embodiments.

As shown in FIG. 2, for detecting UV, visible light, and IR radiations, electronic system 200 includes sensor module 202, analog front end 204, analog to digital converter (ADC) 206, digital hardware 208. Optionally, the electronic system 200 includes a telemetry unit 210, gain I sensitivity adjustment module 212, and an energy harvesting module 216. FIG. 2 illustrates just one possible design. Other embodiments may have more or fewer components than those illustrated in FIG. 2.

In some embodiments and configurations, the wearable sensor device also can have a display screen. The display screen can be touch sensitive and enable user input of clinical information data re clinical information data relevant to estimate a personalized evolution in disease activity, trigger skin aging, or put the user at risk for some diseases upon which recommendations can be made, such as to apply sunscreen, apply more sunscreen, limit radiations exposure coming from sunlight or artificial sources, or end radiations exposure.

Telemetry unit 210 can include one or more of an antenna or radio frequency (RF) transmitter and wireless transceiver that allows the wearable sensor device to communicate using a wireless connection in the form of a Wi-Fi connection, a Bluetooth connection, a low-energy Bluetooth connection, or any other form of wireless tethering or near field communication. It also can include a cellular connection to the Internet.

Sensor module 202 also can comprise one or more sensors that detect incident radiations and transduce the incident radiations into one or more corresponding analog signals. As shown in FIG. 2, in some embodiments, the sensor module 202 optionally includes a separate visible light sensor 202-a, and a separate UV sensor 202-b (e.g., comprising a UVA sensor and a UVB sensor or comprising a UVA, UVB, and UVC sensor). In alternative embodiments, the visible light sensor 202-a, and the UV sensor 202-b may be combined into a single sensor or a total UV sensor and separate UVA, UVB, and UVC sensors. Having separate UVA, UVB, and UVC sensors, in addition to a total UV sensor can enhance and improve the ability to measure UV exposure accurately by enabling a check to be performed on the data based on using the equation Total UV=UVA+UVB or Total UV=UVA+UVB+UVC. The sensor module 202 also can include an IR sensor 202c for detecting IR radiation, and LED 202d that also enables the IR sensor to be used for Motion Detection.

In some embodiments, the wearable sensor device can further include a display screen. The display screen can be a touch sensitive screen that can be used to see presentation of UV and ambient light exposure information. The touch sensitive screen also can be used for entry of clinical information data relevant to estimate personalized evolution in disease activity or risk level from radiation exposure. The display screen also can be an LED screen that can interrogate the wearable sensor devices, including wearable sensor devices 102, 104, 106, 108, and others in conjunction with the IR sensor and its associated IR source 202e.

Analog front end 204 includes circuitry for providing bias voltages and/or currents to the sensor module 202 for appropriately biasing the one or more sensors in the sensor module 204 at desired or optimum operating points. Furthermore, analog front end 204 includes circuitry for providing analog signal conditioning (e.g., amplifying, filtering, averaging, aggregating, combining, and so on) of the one or more analog signals received from the sensor module 202.

ADC 206 converts the conditioned (e.g., amplified, filtered) one or more analog signals to a digital representation for use (e.g., further processing) and storage by digital hardware 208.

Digital hardware 208 (e.g., comprising a computer with a processor and memory, a digital signal processor, a hand held device, and the like) receives the digital representation of the conditioned one or more analog signals, processes the digital representation, and optionally stores the digital representation in memory to store the data for infrequent transmission to one or more remote computing devices (not physically coupled to the electronic system 200). In some embodiments, digital hardware 208 may include computer or electronic code with one or more instructions that process (e.g., interpret, manipulate, combine, use for decision making, and so on) the digital representations of the one or more signals received from sensor module 202. For example, digital hardware 208 may use the one or more signals for making diagnostic decisions regarding potential over-exposure and under-exposure to radiations (e.g., as a deviation from recommended thresholds or baseline levels of visible light intensity, UV, and IR radiation). The digital hardware 208 may also store clinical information data relevant to estimate personalized evolution in disease activity or risk level from radiation exposure and use that data and the sensor module data for decision making, including decision making and monitoring of an amount and time of safe UV exposure, time of safe radiation exposure, application of sunscreen, and use of protective clothing.

In other embodiments, the exposure data received from the sensor module 202 and the clinical information data may be communicated via the telemetry unit to one or more server computers for analysis with the results being communicated back to the wearable sensor device or a remote computing device paired with or connected to the wearable sensor device.

Some examples of recommended ranges of visible light and UV exposure are as described below. For patients with conditions such as primary depression or secondary depression due to chronic pain (e.g., Fibromyalgia), the recommended light exposure is approximately +/−2,500 Lux/week.

For optimal UV-induced Vitamin D production, a few short sun exposures a week, approximately 30.0 to 74.0 nanograms per milliliter (ng/mL), are recommended to keep a sufficient vitamin D level. In some embodiments, approximately 1 to 3.0× standard erythema dose (SED)=10 minutes of summer noonday sun exposure every 2 weeks has been recommended.

On the other hand, with regard to prevention of UV induced sunburn (e.g., correlated with increase in risk of skin cancer and photoaging), when the UV-Index is 3, a fair skinned person might experience minimal skin redness (e.g., sunburn) after one hour of sun exposure. When the UV-Index is 6, a fair skinned person might experience minimal skin redness after 24 minutes of sun exposure, and when the UV-Index is 10, a fair skinned person will experience minimal skin redness after 6 minutes of sun exposure. In some embodiments, UV-Index levels over 7 might result in a fair skinned person burning after 15 minutes of sun exposure.

Remote computing devices, such as a cellular telephone, smartphone, smart glasses, smart watches, or a tablet computer paired or connected with the wearable sensor device, can be used to input clinical information data clinical information data relevant to estimate a personalized evolution in disease activity, trigger skin aging, or put the user at risk for some diseases. In some embodiments, the digital clinical information data relevant to estimate a personalized evolution in disease activity, trigger skin aging, or put the user at risk for some diseases data can be transmitted to a remote physician or health care facility for diagnostic purposes. In other embodiments, it is transmitted to a user's mobile phone or other computing device, or to the computing devices of one or more other users or to remote server computers.

In some embodiments, gain/sensitivity adjustment module 212 provides adjustment signal 270 to analog front end 204 and/or to the sensor module 202 in order to modify one or more parameters of the circuitry of the analog front end 204 (e.g., to modify gain or amplification, filter cutoffs, and so on) or to modify a sensitivity or resolution of the one or more sensors of the sensor module 202, based on ambient conditions. For example, in bright outdoor environments, with high ambient light intensity, the amplification or gain of an amplifier in the analog front end 204 or a sensitivity of the light intensity sensor 202-a is reduced to capture the light intensity within the full dynamic range of the amplifier and light intensity sensor 202-a. As a result, using the gain/sensitivity adjustment module 212, the wearable UV, visible light, and IR sensor can be used to measure and monitor the amount of radiations that a person receives in a wide range of environments (e.g., indoors in artificial light, indoors in diffused or indirect natural light, outdoors in direct sunlight, in tanning beds, and so on). This adjustment signal 270 may be generated by the gain/sensitivity adjustment module 212 based on feedback signal 260 provided by digital hardware 208 in response to a detected signal from the sensor module 202, or based on manual settings specified by a user via user input 250.

In some embodiments, energy harvesting module 216 comprises a sensor to receive light (e.g., solar) energy and convert the light energy into electrical energy that can be used to power one or more components of the electronic system 200. In some embodiments, energy harvesting module 216 comprises a battery or any other storage element capable of storing electrical energy obtained from the received light energy. In such embodiments, the battery is charged or recharged directly from the light or solar energy. Alternatively, the energy harvesting module 216 receives and stores the light energy (or an electrical signal generated from the light energy) directly from sensor module 202 to power one or more components of the electronic system 200.

Ultraviolet radiation received at the sensor module is measured terms of power over the surface area of the sensor, e.g., mW/cm². That data is integrated over the time of exposure to provide UV exposure data measured in energy over surface area of the sensor, e.g., mJ/cm². Each person has a different tolerance to UV radiation, based on clinical information data relevant to estimate a personalized evolution in disease activity, trigger skin aging, or put the user at risk for some diseases, including age, gender, skin type, skin diseases, other diseases, and medical conditions. It is advantageous to determine the tolerance to UV radiation from both sunlight in different locations, weathers, and altitudes, and artificial UV sources (e.g., tanning beds or any apparatus emitting UV radiation).

Data received at the sensor module 202, and the clinical information data of the user of the wearable sensor device and other users of the wearable sensor device are used to determine a personalized radiation pattern for disease prevention and a personalized radiation pattern for an evolution in disease activity or skin aging. The wearable sensor device and a remote computing device paired or connected to the wearable sensor device can be programmed and configured to receive an alert prior to a personalized radiation pattern that would likely trigger a disease and a personalized radiation pattern that would trigger an evolution in disease activity has been received and after a personalized radiation pattern that would likely trigger a disease and a personalized radiation pattern that would likely trigger an evolution in disease activity has been received.

### Clinical Information DataRelevant to Estimate Personalized Radiation Patterns for Disease Prevention, an Evolution in Disease Activity, or Skin Acing

Clinical information data relevant to estimate a personalized radiation patterns for disease prevention, an evolution in disease activity, or skin aging, and risk level from radiation exposure can include age, skin type or tone (fairness of skin, number of freckles, number of moles, characteristics of the moles, etc.), gender, pregnancy, smoking habits, past radiation exposure (measured and estimated through questions), pre-conditions, genomics (familial and personal history of skin cancer, photosensitivity, genetic mutations and polymorphisms, epigenetic modifications), skin reactions, skin rashes and other symptoms, sunburns, vitamin D levels from blood tests, medication history (current and past), history of surgeries and scars, history and usage of products applied to the skin (including sunscreens, tanning oils, fragrances, etc.), occupational and recreational activities, tanning bed use and prior history of sun avoidance and protective clothing or other outerwear should be emphasized as important measures of photo-protection for patients with photosensitivity disorders. Sunscreen alone is not sufficient and should be used as an adjunct to other methods of sun protection. Radiations have even been shown to be in the environment indoors, such as buildings, cars, airplanes. With the present invention, personalized photoprotection can be recommended.

### Personalized Radiation Patterns for Disease Prevention

Several diseases have been shown to be triggered or accelerated by under-exposure or over-exposure to electromagnetic radiations (UV, visible light, IR). These diseases include all forms of skin cancer (melanoma, non-melanoma, etc.), all forms of vitamin D deficiency (temporary deficiency, osteomalacia, osteoporosis, rickets, etc.), all forms of epilepsy, all forms of seasonal depressions (seasonal affective disorder, etc.), all forms of phototoxicity and all forms of cataract. Early signs or tests indicating the potential of development of these diseases or the diagnosis of these diseases can be reported and used to estimate a personalized safe radiations level. For skin cancer, these signs or tests are for instance (but not limited to) the minimal erythemal dose (MED), the reporting of sunburns (their location, their sizes, their level of pain, their level of redness, etc.), the detection of DNA lesions, actinic keratosis, perivascular lymphocytes, histiocytes, etc. All tests described hereafter (laboratory tests, imaging studies, dermatological and clinical examinations or observations) can also be used for indicators of disease formation or development.

Erythema (inflammation) is the most obvious clinical sign of UV radiation exposure and is apparent from about 6 hours after exposure and is maximal at about 24 hours. Minimal erythema dose (MED), defined as the smallest UV dose that causes skin reddening, is frequently used as an indicator of UV sensitivity.

The table below shows ultraviolet radiation doses reported as required to produce erythema responses in normal human skin adapted from L. A. Mackenzie, Br. J. Dermatol. (1983) 108:1-9:

| Wavelength (nm) | MED (mJ/cm2) | 95% Confidence limit (mJ/cm2) |
|---|---|---|
| 254 | 4.3 | 1.5-13 |
| 295 | 12.5 | 8-21 |
| 300 | 27 | 14-51 |
| 305 | 60 | 28-132 |
| 310 | 270 | 113-644 |
| 315 | 1150 | 480-2740 |
| 335 | 5250 | 1600-17300 |
| 365 | 14800 | 7600-29000 |

However, as shown by the table above, the MED depends on the spectrum of radiations and could be different for sunlight in several conditions, depending on the season, the geolocation, the weather, and the altitude. Also, the usefulness of erythema dose in predicting the extent of risks of UV exposure has limitations. Data on correlations between erythemal response and DNA damage are controversial.

For Vitamin D deficiency, these signs or tests are for instance (but not limited to) blood tests of vitamin D levels, bone radiographies, morphometrics, etc. For epilepsy, these signs or tests are for instance (but not limited to) the reporting of seizures, brain magnetic resonance imaging tests, etc. For seasonal depressions, these signs or tests are for instance (but not limited to) depression test/scales, bright light trial treatments, etc. For cataracts, these signs or tests are for instance (but not limited to) visual acuity, slit-lamp examinations, retinal examinations, etc. For all these diseases, the use of laboratory tests, imaging studies, and dermatological and clinical examinations or observations described below can also be used to detect early signs of disease development.

A personalized radiation pattern for disease prevention is the estimation and identification of a pattern of UV, visible light, IR radiation doses that puts the user or patient at risk for diseases but does not trigger disease. Personalized radiation patterns are quantified in energy per surface area (e.g., mJ/cm2 or Lux for visible light) and per time unit (e.g., seconds, minutes, hours, days, months, year).

Radiation patterns play an important role. For instance, a single sub-erythemal exposure is below the threshold of detection by the eye. However, this does not mean that it has no effects because repeated daily sub-erythemal exposure results in clinically visible erythema after 2-3 exposures especially in skin phototypes I and II.

### Personalized Radiation Pattern for an Evolution in Disease Activity or Skin Acing

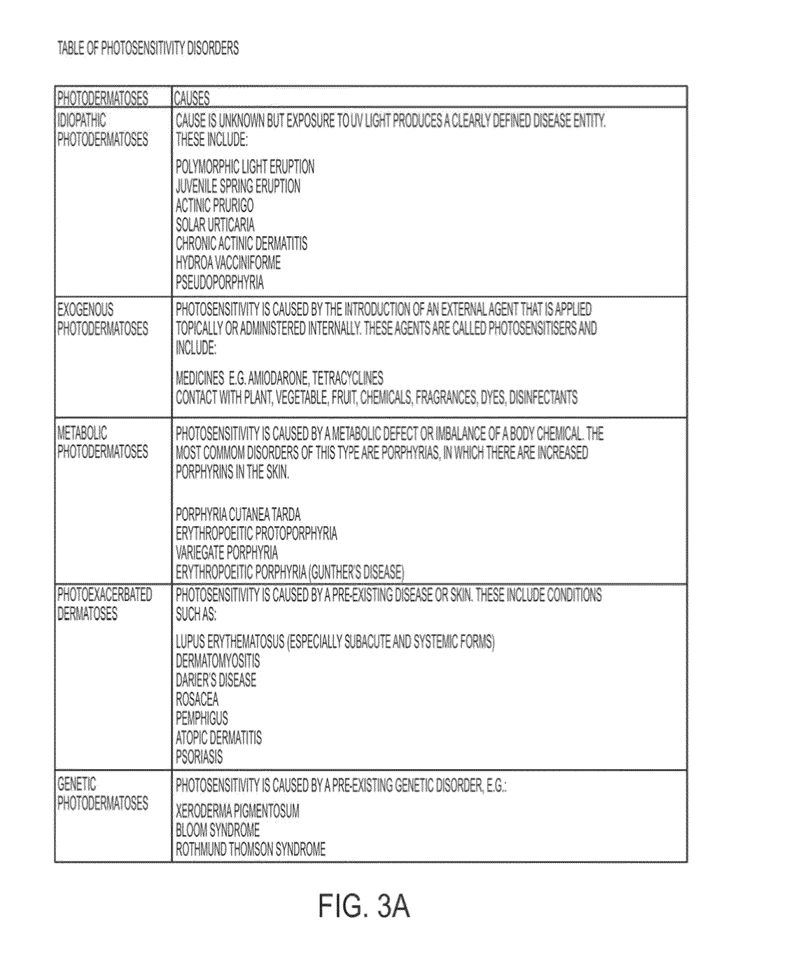

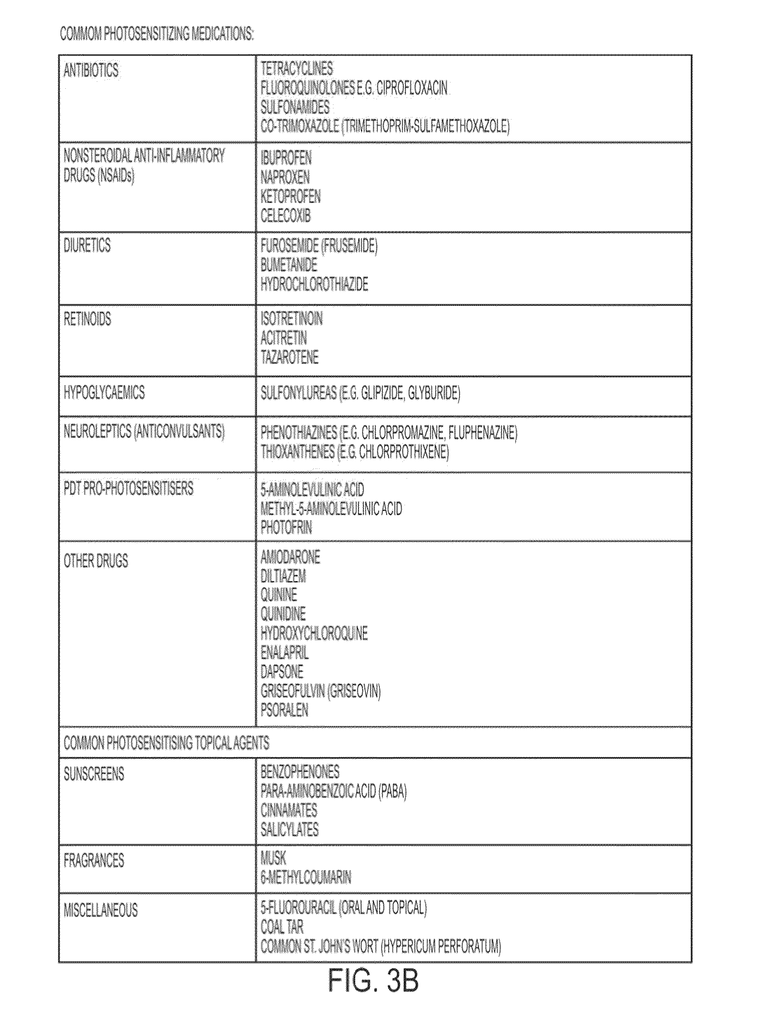

The diseases described previously, photosensitivity disorders (FIG. 3A) and skin aging, are likely to evolve because of radiation exposure. It is thus important to continue monitoring radiation exposure and report any clinical results, observations, or treatments in order to estimate the personalized radiation pattern for an evolution in disease activity or skin aging. The personalized radiation pattern for an evolution in disease activity or skin aging is the identification and estimation of a pattern of radiation doses that will trigger an evolution, whether positive or negative, in disease activity or skin aging. Evolutions in disease activity or skin aging are any reported observations and tests that differ from the user's baseline or expected values or observations. These reports can be classified in three categories: laboratory tests, imaging studies, dermatological and clinical examinations or observations. Finally, it is important to report any treatment or medication.

For instance, a lupus patient may be tested with excessive protein concentration in the urine after being exposed to a pattern of irradiations (e.g., two hours in sunlight). This test could be considered as an evolution of her/his disease activity because of the pattern of irradiations. It is also likely that sunlight exacerbates lupus by increasing expression of autoantigens and adhesion molecules on keratinocytes, as well as cytokine production in the skin.

For instance, a patient diagnosed with skin cancer may have a few of his moles evolve, either in shape, size, color, symmetry over the course of his/her radiation exposure (e.g., a winter in New York). This is also an evolution in disease activity.

UV radiation can locally and systemically suppress the induction of primary, or reactivation of memory immunity in humans. As a result, UV radiation can be an effective therapy for chronic autoimmune disorders such as psoriasis. There is a time dependence between UV irradiation and the discernable effects on the immune system, with mechanisms induced by UVB requiring only 24 hours, while UVA takes longer, but the largest immunosuppressive effect is obtained when these mechanisms are allowed to act in synergy and becomes observable 3 days post-irradiation.

Other examples of laboratory tests are (but not limited to) histological analysis, genetic and epigenetic tests, CBC with differential, Serum creatinine, Urinalysis with microscopy, ESR or CRP results, complement levels, liver function tests, pancreatic enzymes tests, creatine kinase assay, spot protein/spot creatinine ratio, antibody tests, cardiac markers, tumor markers. The quantification of neutrophils, lymphocytes and other cells can be correlated to UV radiations. For instance, acute erythemal exposures of UVB and UVA result in a marked inflammatory infiltrate including neutrophils.

Examples of imaging studies are (but not limited to) bone and joint radiography, chest radiography, chest CT scanning, echocardiography, brain MRI/MRA, cardiac MRI, scintigraphy, pet CT and body scan.

Examples of dermatological and clinical examinations or observations are (but not limited to) skin biopsies, macule, patch, papule, nodule, plaque, vesicle, bulla, pustule, abscess, scale, crust, ulcer, fissure, atrophy, lichenification, lesion or mold analysis (size, type, shape and symmetry, color and pigmentation), pruritus, pain, burning, stinging, and duration. Other symptoms reported by clinicians or the patients include itchiness, redness, sunburns, blisters, swollen or painful skin, urticaria on sun-exposed skin areas (face, scalp, etc.) and anywhere on the body.

Skin aging has several clinical impacts can be observed and quantified in several ways. For instance, the number of pigment-containing cells (melanocytes) decreases, but the remaining melanocytes increase in size. Aging skin thus appears thinner, more pale, and clear (translucent). Large pigmented spots (called age spots, liver spots, or lentigos) may appear in sun-exposed areas. Changes in the connective tissue reduce the skin's strength and elasticity. This is known as elastosis and is especially pronounced in sun-exposed areas (solar elastosis). Elastosis produces the leathery, weather-beaten appearance common to farmers, sailors, and others who spend a large amount of time outdoors. The blood vessels of the dermis become more fragile. This leads to bruising, bleeding under the skin (often called senile purpura), cherry angiomas, and similar conditions. Sebaceous glands produce less oil as aging progresses. This can make it harder to keep the skin moist, resulting in dryness and itchiness. The subcutaneous fat layer thins, reducing its normal insulation and padding. This increases the risk of skin injury and reduces the ability to maintain body temperature. Some medications are absorbed by the fat layer, and loss of this layer changes the way that these medications work. Growths such as skin tags, warts, and other blemishes are more common in older people.

A personalized radiation pattern for an evolution in disease activity or skin aging is a pattern of UV, visible light, and IR radiations likely to trigger an evolution in disease activity or accelerate skin aging. Radiation patterns are quantified in energy per surface area (e.g., mJ/cm2 or Lux for visible light) and per time unit (e.g. second, minute, hour, day, month, year).

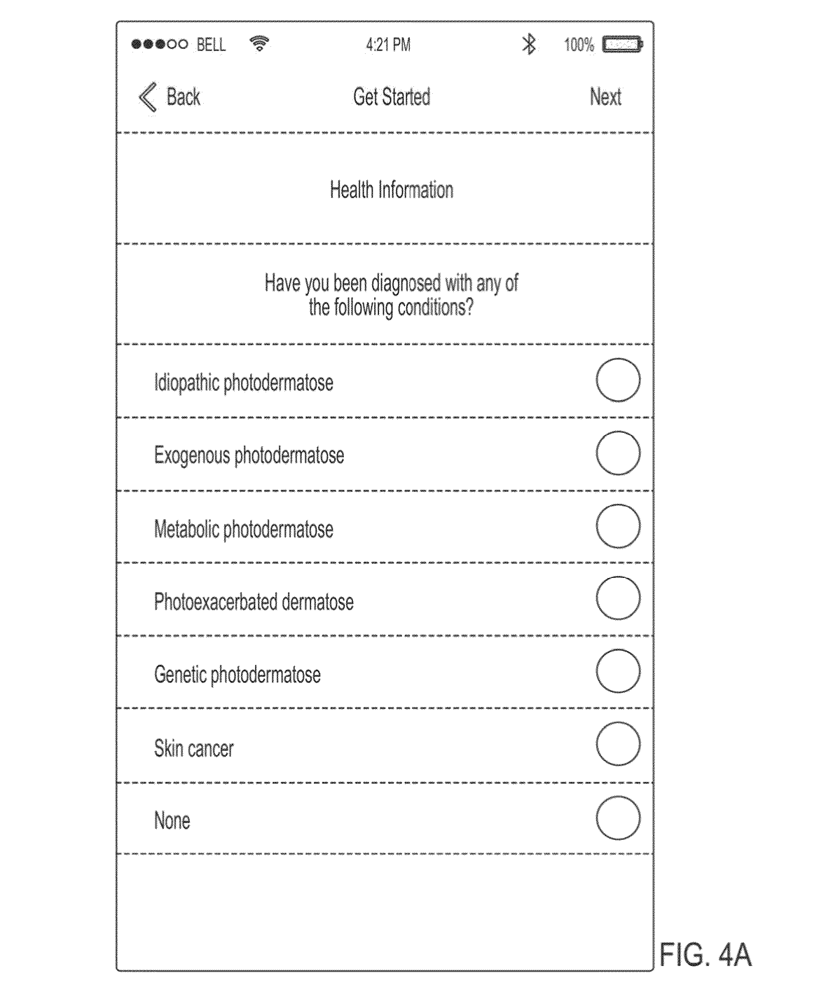

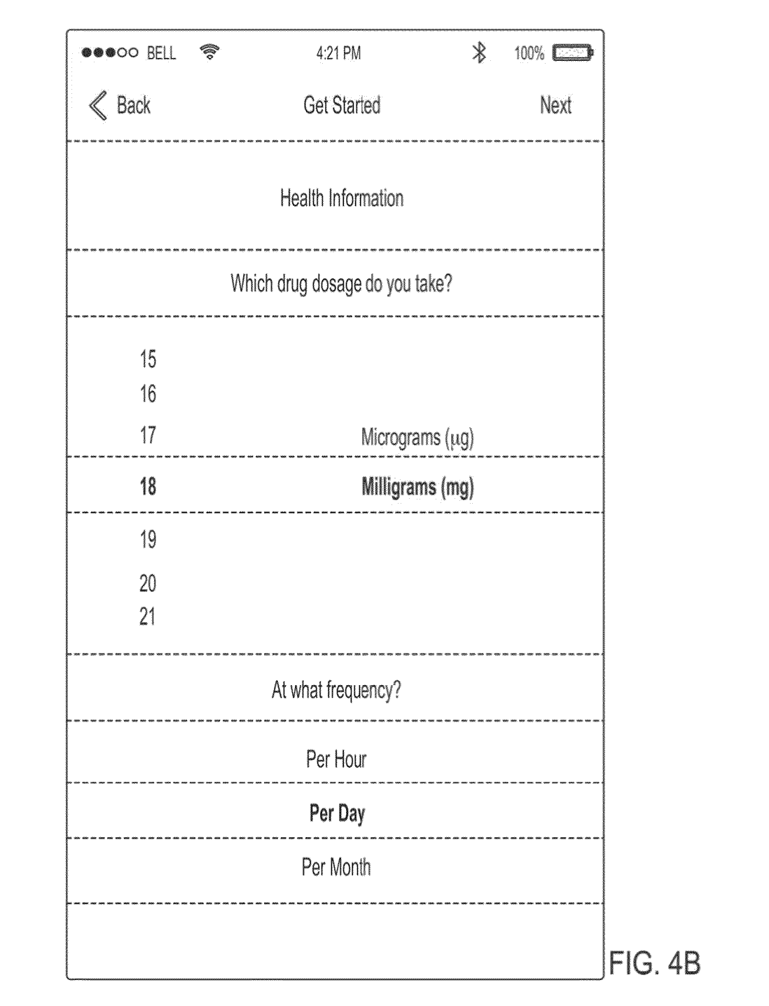

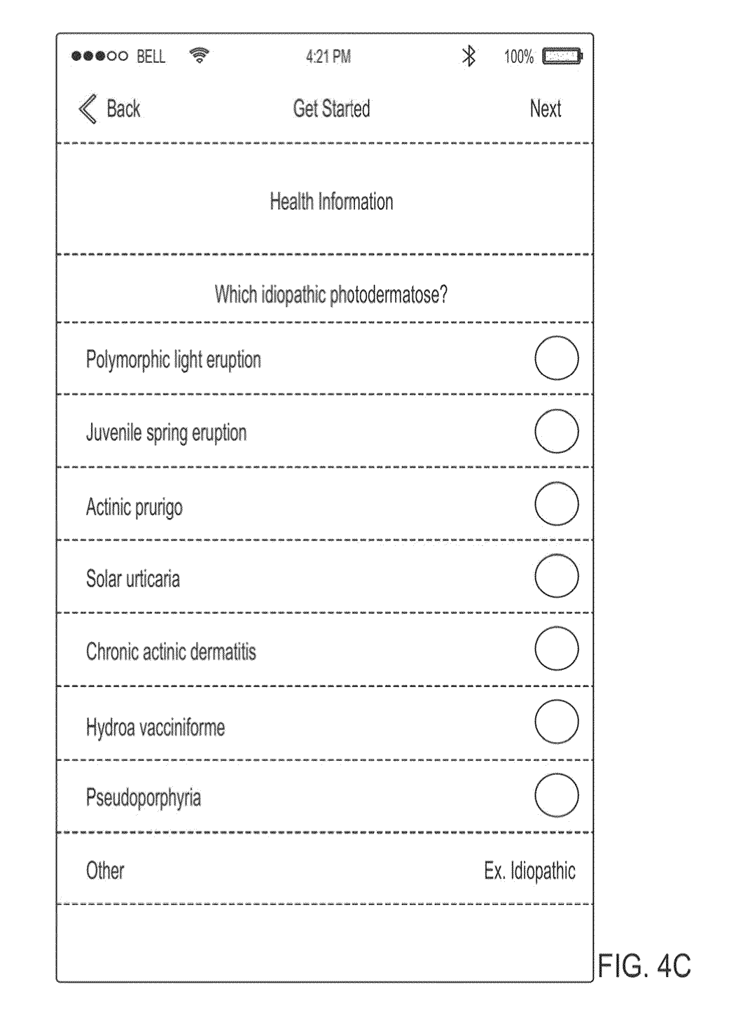

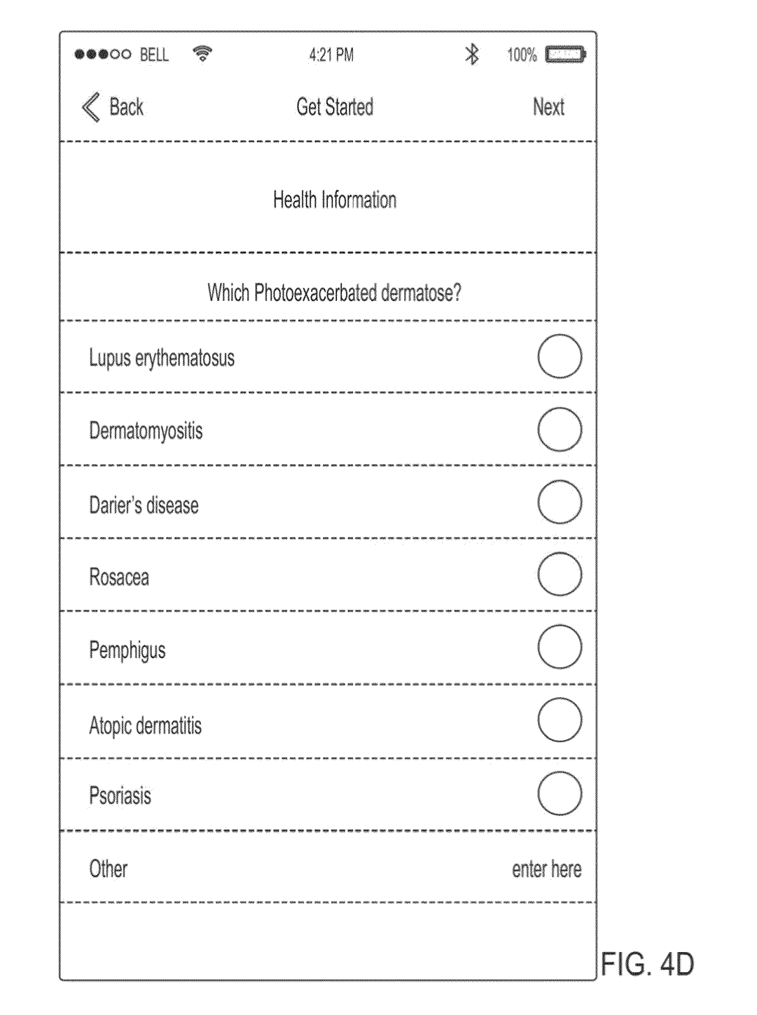

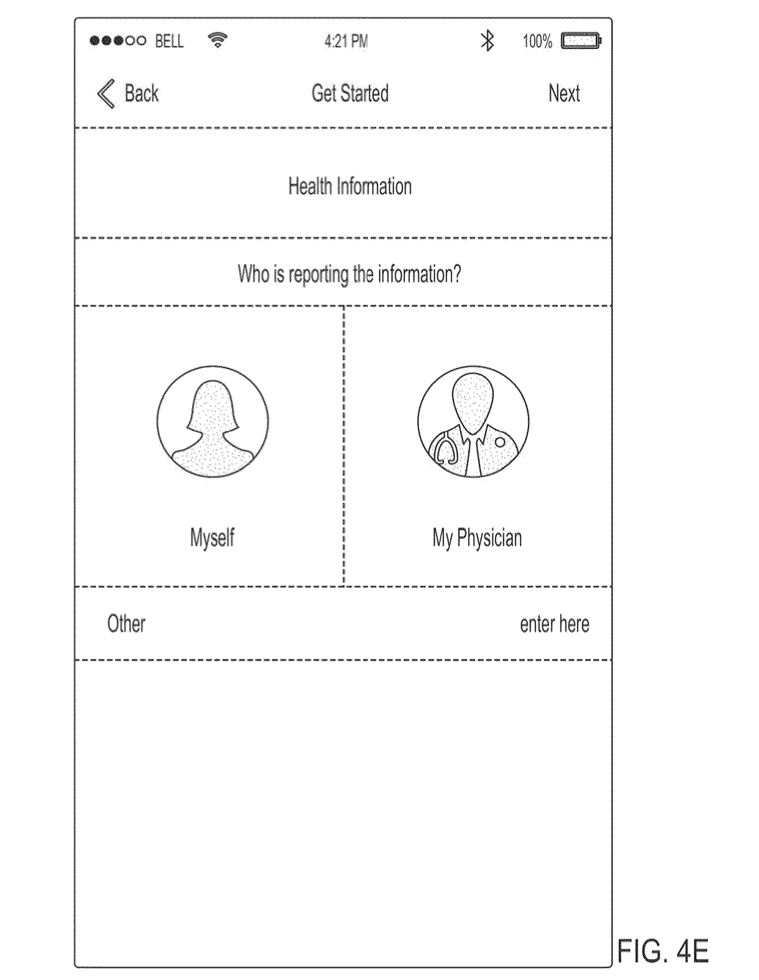

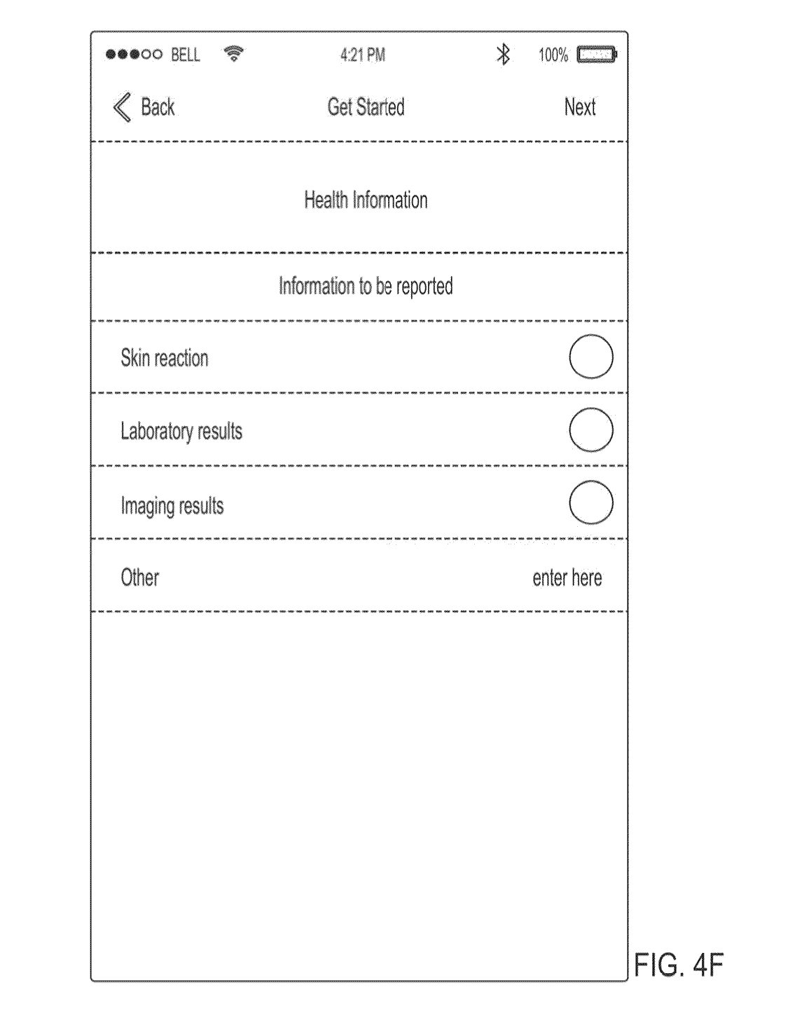

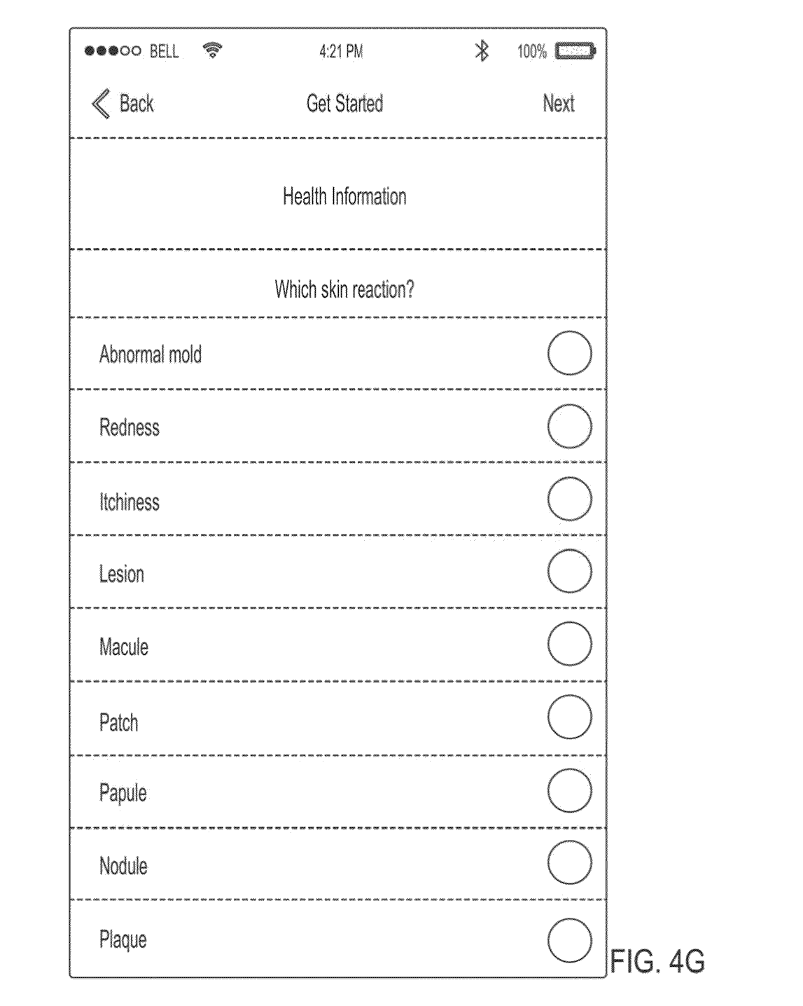

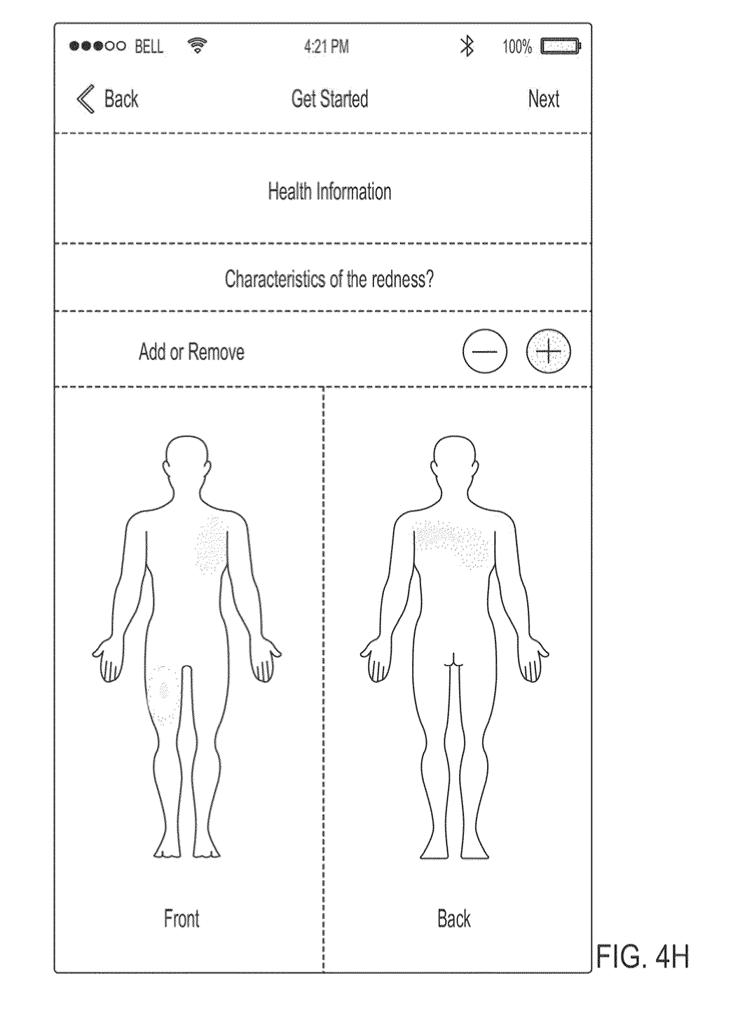

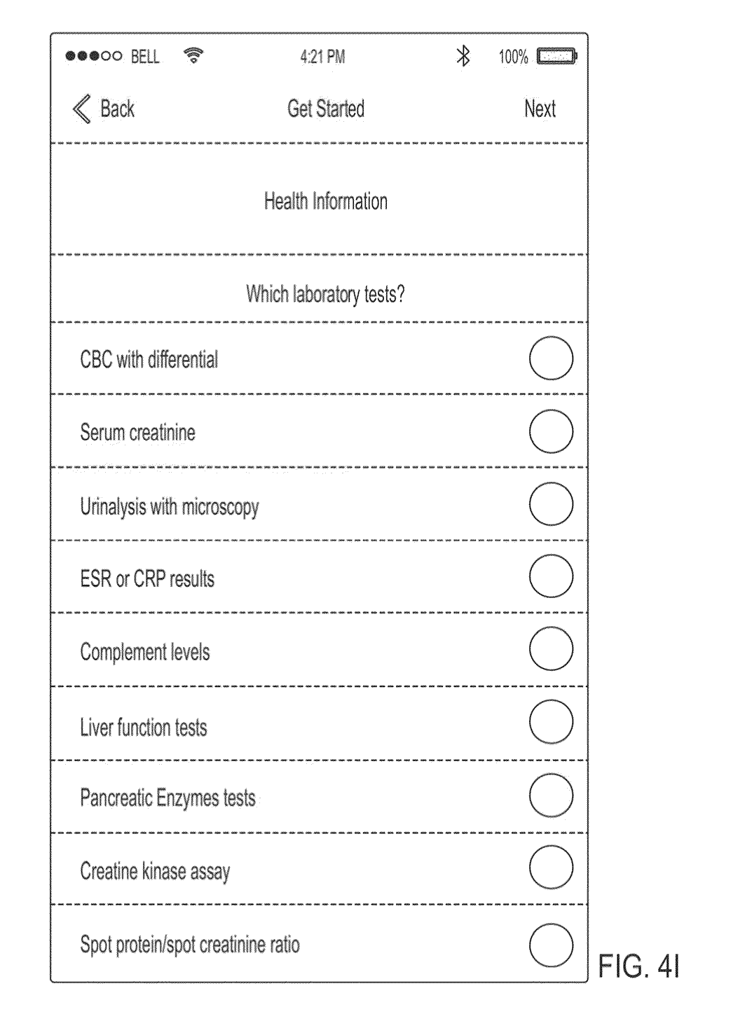

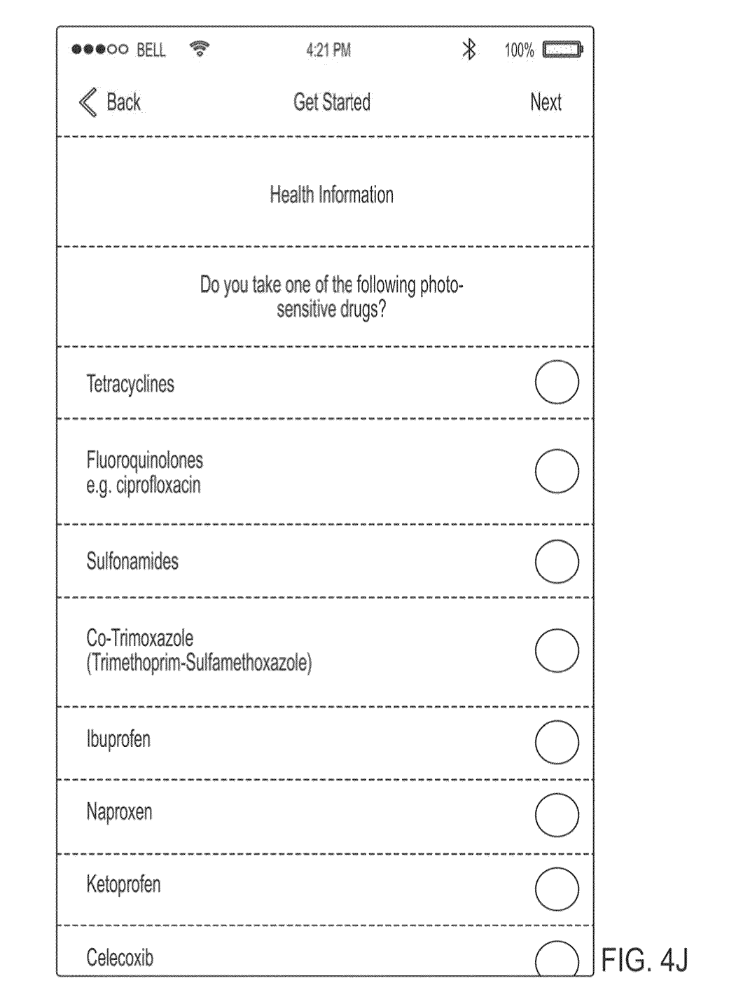

All types of clinical information data relevant to estimate an evolution in personalized disease activity or risk level from radiation exposure described before can be entered into a remote computing device paired with or connected to the wearable sensor device, or in some embodiments, via the device itself. FIGS. 4A-4J are examples of how such information can be collected via a smartphone paired with or connected to the wearable sensor device.

### Medications, Treatments, and Topical Agents

Medications, treatments and topical agents are also medical information that can affect the estimation of the radiation pattern for an evolution in disease activity. Examples of these medications are Tetracyclines (especially doxycycline) include Thiazides, Sulfonamides, Fluoroquinolones, NSAIDS (especially piroxicam and ketoprofen), Phenothiazines (e.g., chlorpromazine), Psoralens, Griseofulvin, Voriconazole, Aminolevulinic acid and methyl aminolevulinate, Porfimer sodium, Retinoids, Tar compounds, and St. John's wort. A more comprehensive list is presented in FIG. 3B.

Systemic medications that can induce photoallergic and phototoxic reactions include quinidine, griseofulvin, quinine, quinolones, sulfonamides, ketoprofen, acutane, tetracycline, and piroxicam.

Treatments include chemotherapy, radiotherapy, etc. Daily dose, cumulative dose, treatment duration are relevant information to estimate the patient risk level for phototoxicity.

The most common topical agents responsible for photoallergic reactions are sunscreens (e.g., benzophenones, cinnamates, dibenzoylmethanes), antimicrobial agents (e.g., bithionol, chlorhexidine, hexachlorophene, fenticlor), NSAIDs (e.g., ketoprofen, diclofenac), fragrances (e.g., 6-methylcoumarin, musk ambrette, sandalwood oil), Phenothiazines (e.g., promethazine, available in Europe as topical antihistamine). A more comprehensive list is presented in FIG. 3B.

All the above information can be entered into a remote computing device paired with or connected to the wearable sensor device, or in some embodiments, via the wearable sensor device itself.

The wearable sensor is configured and programmed to monitor UV, visible light, and IR radiations continuously, receive feedback from users, and present information on radiation exposure, and radiation exposure-related recommendations. The analysis of the data can be done on the wearable sensor device or on a remote computing device or devices connected to or paired with the wearable sensor device, including a smart phone or tablet computer or server computer system and then communicated to the wearable sensor device or a remote computing device paired with or connected to the wearable sensor device.

### Presentation of Radiation Exposure Data and Recommendations

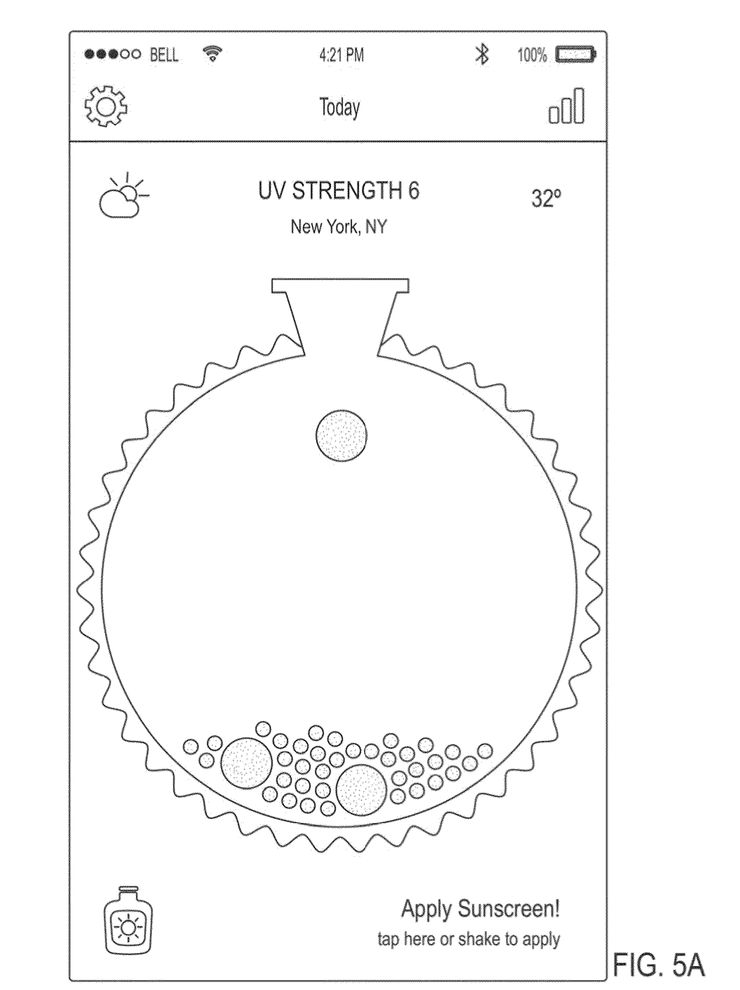

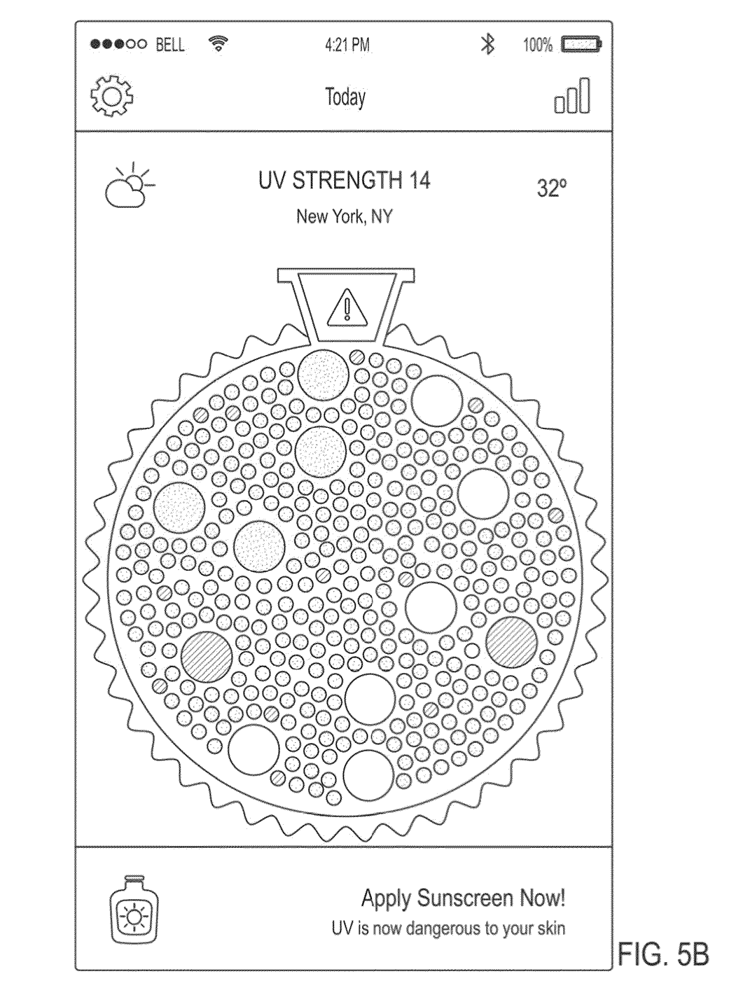

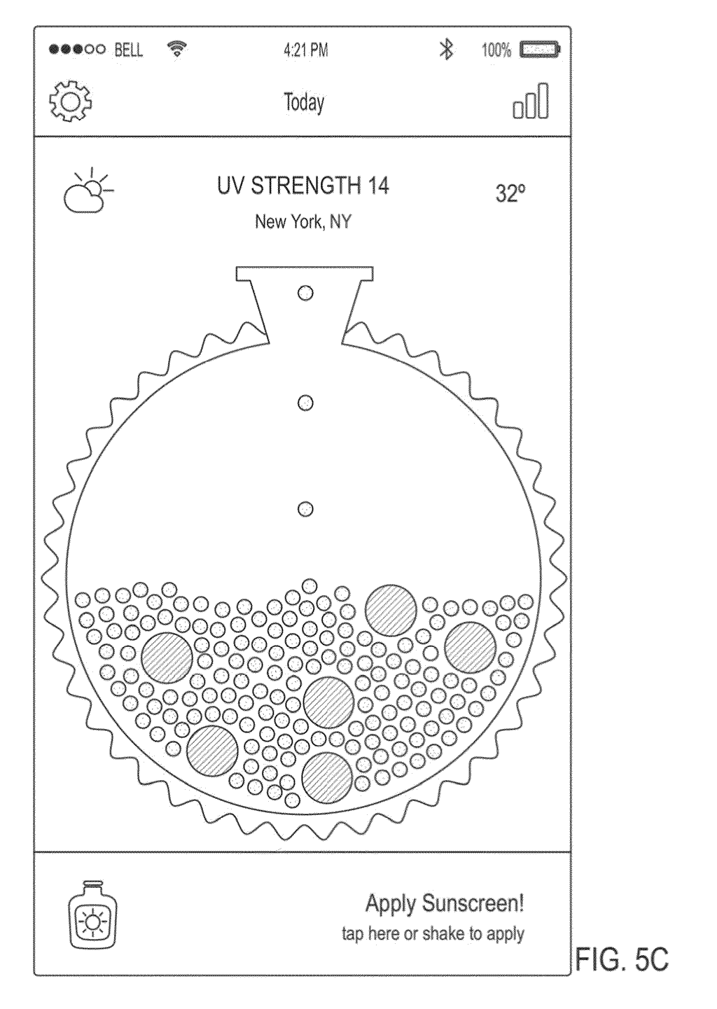

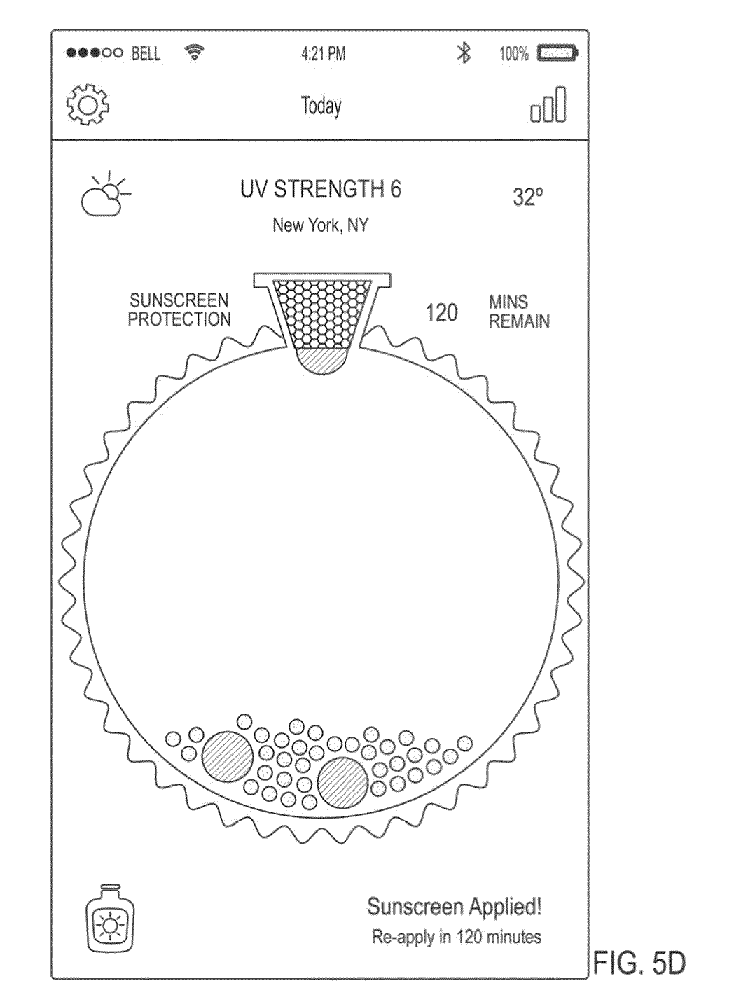

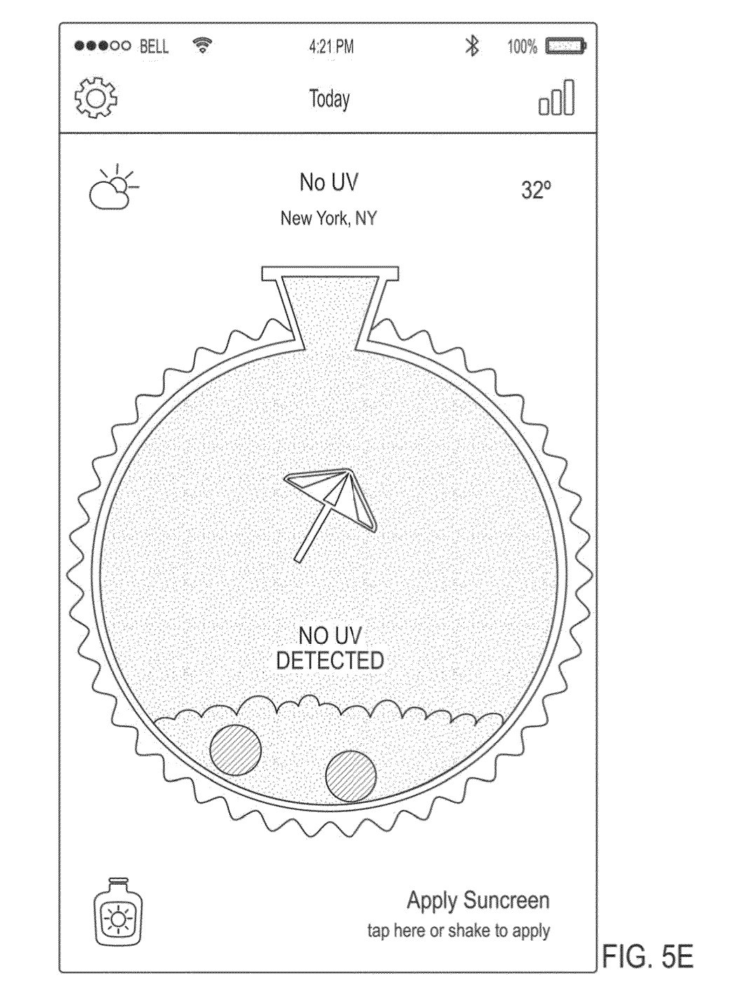

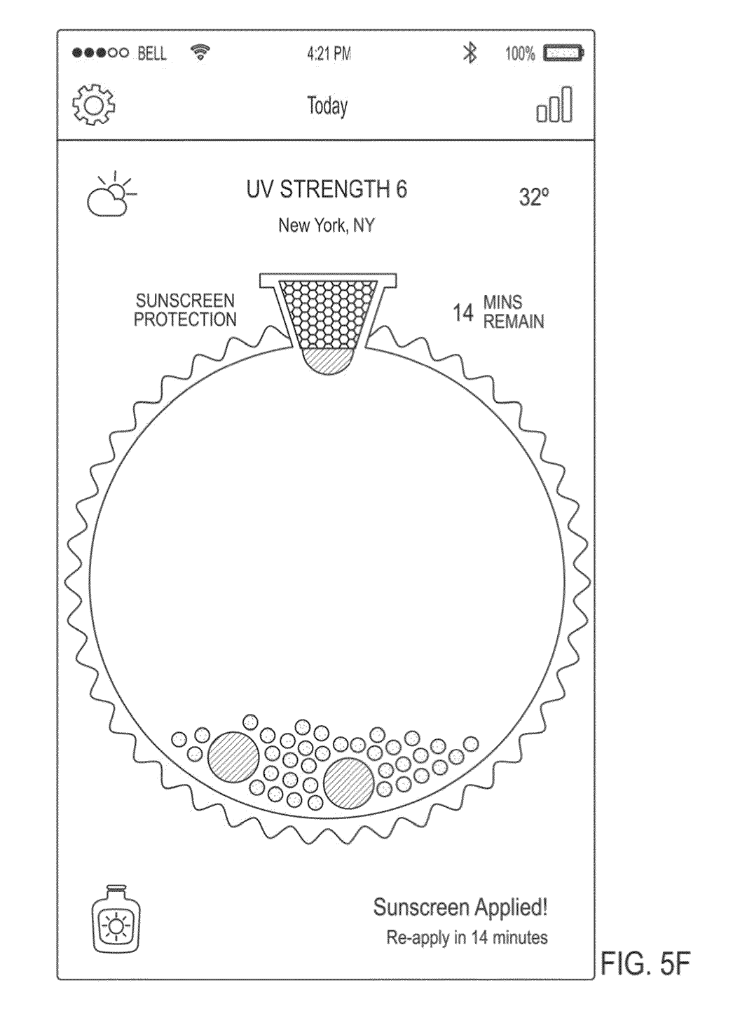

FIGS. 5A-5F are examples of how UV exposure can be depicted in a software application running on a portable computing device, such as a smartphone or tablet computer connected to or paired with the wearable sensor device. For example, big spheres can represent UVB radiation (more harmful and lesser in quantity than UVA in sunlight radiation). Smaller spheres represent UVA radiation exposure. The amount of safe UV exposure can be depicted with a filling bottle shape. As UV exposure increases, the bottle fills. It also can be depicted numerically or graphically in other ways. The UV strength can be depicted numerically or graphically. Location services or GPS tracking in the remote computing device can identify the location of the paired or connected wearable sensor device to identify UV strength for that location and use it to identify a personalized radiation pattern for disease prevention and the personalized radiation pattern for an evolution in disease activity and making personalized UV exposure-related recommendations.

Radiation exposure data and recommendations can also be depicted on the display screen of the wearable sensor device. Radiation exposure data and recommendations can also be depicted on a software application of a remote computing device paired with or connected to the wearable sensor device. The recommendations can include apply sunscreen, apply sunscreen by a specified time, increase protection, go outside, use sunglasses, limit sun exposure, or cease sun exposure immediately or by a specified time.

### Beneficial UV Exposure Monitoring

Sunlight also has the potential to play a key role in the wellbeing of patients. Indeed, psychiatrists increasingly prescribe bright light therapy as a way to improve symptoms of depression and other psychiatric disorders. Sunlight also has a proven effect on cognitive functions and stimulates the synthesis of vitamin produced in the skin.

A meta-analysis of three randomized trials looking at non-seasonal depression confirmed that as little as 2,500-lux light exposure for at least two hours per day for one week yielded significant improvement in mood disorders. Sunlight or bright light exposure after waking up has also proven to be effective against insomnia. The positive effects of sunlight on sleep patterns can be felt in as little as two weeks.

The data from the sensors can be continuously cross-analyzed with psychosocial characteristics, and give feedback to improve mental well-being. The system has the capacity to estimate a personalized radiation pattern for an evolution in disease activity. Here, the diseases are lack of Vitamin D, depression, seasonal depression (SAD), etc.

Methods of Radiation Detection and Monitoring with the Wearable Sensor Device

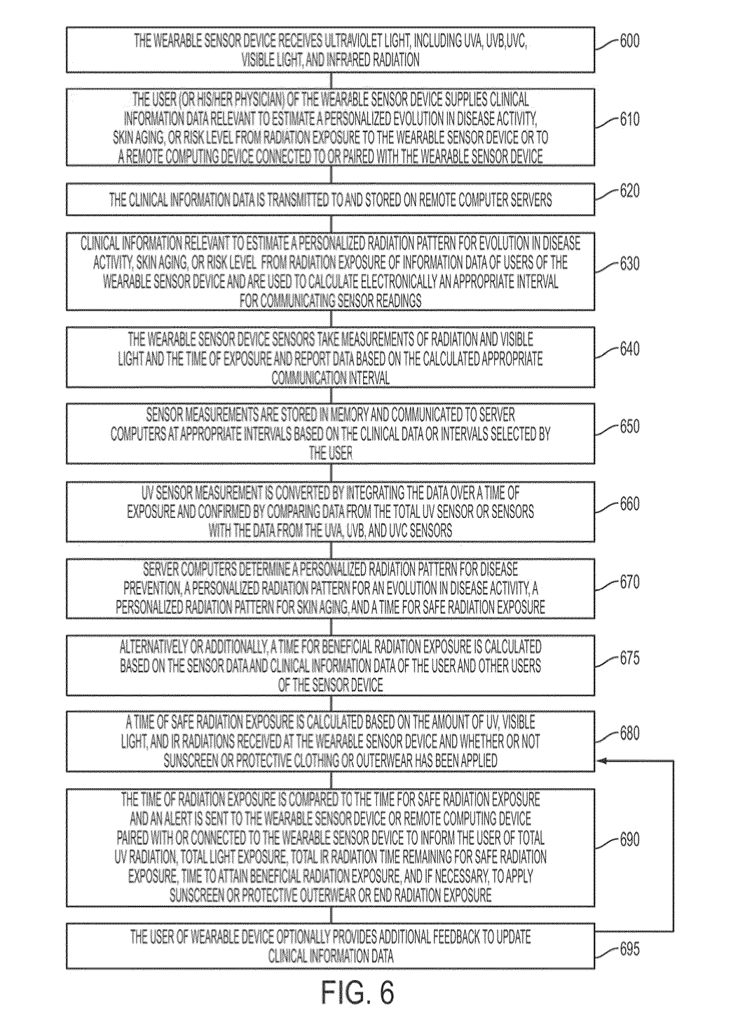

FIG. 6 is a flowchart depicting exemplary methods of radiation detection and monitoring of radiation and making radiation-related recommendations according to one embodiment. As shown in FIG. 6, in step 600, the wearable sensor device receives ultraviolet light, including UVA, UVB, UVC, visible light, and infrared radiation.

In step 610, the user (or his physician) of the of the wearable sensor device supplies clinical information relevant to estimate a personalized pattern for an evolution in disease activity, skin aging, or risk level from radiation exposure to a remote computing device paired with or connected to the wearable sensor device. The clinical information includes, for example, including for example, gender, age, skin type, and medical conditions, and any skin-related symptoms, as well as information on sunscreen application or protective clothing and in the geographic location of the wearable sensor, from which the strength of radiations can be determined.

In step 620, the clinical information data is transmitted to and stored on remote computer servers. In other embodiments, the clinical information data could be stored on the wearable sensor device or other remote computing device paired with or connected to the wearable sensor device.

In step 630, the clinical information relevant to estimate a personalized radiation pattern for an evolution in disease activity, skin aging, or risk level from radiation exposure of information data of the user of the wearable sensor device and other users of the wearable sensor device and the received sensor data are used to calculate electronically an appropriate interval for communicating sensor readings. The period could be over appropriate intervals of seconds, minutes, hours, days, or months. For example, for a person with diseases or medical conditions that can be exacerbated or affected by UV radiation exposure more quickly and with greater risk of damage, the interval will be shorter than for a person without such concerns. Alternatively, the user could set communication intervals that are longer or shorter than those determined appropriate based on clinical information data.

In step 640, the wearable sensor device sensors take measurements of total UV radiation, UVA radiation, UVB radiation, and visible light, infrared radiation, and other parts of the electromagnetic spectrum, and the time of exposure and report data based on the calculated appropriate communication interval.

In step 650, those measurements are stored in memory and transmitted to a smartphone, tablet, or other remote computing device paired with or connected to the wearable sensor device via Bluetooth Low energy transmission at appropriate intervals based on the clinical data or intervals selected by the user. Alternatively, or additionally, the clinical information data can be stored in the memory of the remote computing device and directly communicated from the wearable device to the server computers.

In step 660, the data received from the UV sensors at the servers is converted based on integrating the data over the time of exposure and confirmed in embodiments that use separate UVA, UVB, and UVC sensors and a total UV sensor by comparing the data from the total UV sensor or sensors with the sum of the data from the separate UVA, UVB, and UVC sensors. Alternatively, this conversion and confirmation could be performed by the wearable sensor device or software application running on a paired or connected remote computing device, such as a smartphone, tablet computer or other computing device in other embodiments.

In step 670, the server computers determine a personalized radiation pattern for disease prevention, a personalized radiation pattern for an evolution in disease activity, a personalized radiation pattern for skin aging, and a time for safe radiation exposure, based on the sensor data and the clinical information data of the user of the wearable sensor device, as well as the sensor data and clinical information data of other users of the wearable device. Alternatively, the personalized radiation pattern for disease prevention and the personalized radiation pattern for an evolution in disease activity, or skin aging, and time for safe radiation exposure could be determined by the wearable sensor device or by clinicians or physicians who can access the data, including any pictures of skin symptoms or damage transmitted by the users.

Alternatively or additionally, in step 675, a time for beneficial radiation exposure is calculated based on the sensor data and clinical information data of the user of the wearable sensor device, as well as the sensor data and clinical information data other users of the wearable device.

The personalized radiation pattern for disease prevention and the personalized radiation pattern for an evolution in disease activity or skin aging are enhanced and improved by also using data of users and patients wearing the wearable sensor device and reporting of their physicians.

Self-reporting by users and reporting by physicians can include but is not limited to: age, gender, skin type, is skin tanned, is sunscreen used, phenotype, biomarkers, microbiome composition, collagen elasticity of the skin, collagen composition, blood markers for cardiovascular diseases, skin rashes, melanin content of the skin, serum markers, current treatment, any skin cancer quantifier, any lupus quantifier, autoimmune profile, pollution, family history, past medical history, history of radiation exposure, date and nature of last surgery, number and color of scars, occupational risk factors, profession, minimal erythema dose results, any results from laboratory tests, imaging studies, dermatological and clinical examinations or observations previously described.

Data from a larger group of users helps establish the personalized radiation patterns for disease prevention and for an evolution in disease activity or skin aging for each individual over the appropriate data collection time interval (one minute, one hour, one day, one month, etc.). Personalized patterns can evolve all the time, based on the algorithms.

The personalized radiation pattern for disease prevention and the personalized radiation pattern for an evolution in disease activity, and time for safe UV exposure are calculated with algorithms which use statistics from the field of complex systems and statistical physics: stochastic differential equations, machine learning algorithms (neural networks, etc.).

In step 680, a time of safe UV exposure is calculated based on the amount of radiation exposure received and whether or not protection in the form of sunscreen or protective clothing or outerwear has been applied.

Alternatively, or additionally, in step 685, a time of beneficial radiation exposure is calculated, based on the amount of UV, visible light, and IR radiations received and whether or not protection in the form of sunscreen or protective clothing or outerwear, including sunglasses, has been applied.

In step 690, the radiation exposure is compared to the personalized radiation pattern for disease prevention and the personalized radiation pattern for an evolution in disease activity, and an alert is communicated to the wearable device or to the remote computing device paired or connected to the wearable sensor device to inform the user of the total radiation exposure, time remaining for safe radiation exposure, and if necessary, to apply sunscreen or protective outerwear or end UV exposure.

In step 695, if the user optionally supplies additional feedback to update clinical information, including sunscreen application and any symptoms experienced since clinical information data was last reported, and the feedback loop returns to step 680 and continues with the remaining steps. The additional feedback also can optionally take the form of pictures of changes of the skin from radiation exposure.

The foregoing description of the embodiments of the disclosure has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, Mozilla® Firefox available from Mozilla Corporation, and/or Safari from Apple). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on this application based hereon. Accordingly, the disclosure of the embodiments of the invention is intended to be illustrative, but not limiting, of the scope of the invention.

What is claimed is:

1. A wearable sensor device for monitoring ultraviolet (UV) radiation, visible light, and infrared (IR) radiation comprising:
one or more sensors that measure UV radiation;
a visible light sensor;
one or more sensors that measure IR radiation;
one or more processors;
memory;
a telemetry unit for communicating data received at the sensors and clinical information data relevant to estimate a personalized evolution in disease activity, skin aging, or risk level from radiation exposure from the memory of the wearable sensor device to a remote computing device connected to or paired with the wearable sensor; and an analog to digital converter.

2. The wearable sensor device of claim 1, wherein one of the sensors that measure UV radiation measures UVB radiation.

3. The wearable sensor device of claim 2, wherein one of the sensors that measure UV radiation measure UVA and another sensor measures UVC radiation.

4. The wearable sensor device of claim 3, wherein the telemetry unit further comprises one or more of an antenna or radio frequency (RF) transmitter and wireless transceiver that allows the wearable sensor device to communicate using a wireless connection in the form of a Wi-Fi connection, a Bluetooth connection, a low-energy Bluetooth connection, cellular connection, or any other form of wireless tethering or near field communication.

5. The wearable sensor device of claim 4, further configured and programmed to determine a personalized radiation pattern for an evolution in disease activity, based on the clinical information data of a user of the wearable sensor device and other users of the wearable sensor device, data received from the one or more sensors that measure total UV and IR radiation, and the ambient light intensity sensor, and send an alert to the wearable sensor device or to a remote computing device that is paired with or connected to the wearable sensor device, the alert including apply more sunscreen, total UV exposure, a time remaining for safe UV exposure, and an end time for safe UV exposure.

6. The wearable sensor device of claim 5, further configured and programmed to calculate a personalized radiation pattern for skin aging, risk level from radiation exposure, and personalized radiation pattern for disease prevention, based on the clinical information data of a user of the wearable sensor device and other users of the wearable sensor device, data received from the one or more sensors that measure total UV radiation, and the ambient light intensity sensor.

7. The wearable sensor device of claim 6, wherein the personalized radiation pattern for disease prevention and the personalized radiation pattern for an evolution in disease activity are also calculated from the data received at the UVA sensor, the UVB sensor, and the UVC sensor.

8. The wearable sensor device of claim 7, further comprising a wearable magnetic clip, arm-band, eye glasses, or wrist watch.

9. The wearable sensor device of claim 8, further comprising a rechargeable battery.

10. The wearable sensor device of claim 9, wherein the rechargeable battery receives and stores light energy or an electrical signal generated from the light energy received from one or more of the sensors.

11. The wearable sensor device of claim 8, further comprising:
an LED; and a display screen, wherein the wearable sensor device is in a low power state when the light detector does not detect visible light.

12. The wearable sensor device of claim 11, wherein a housing of the wearable sensor device is shaped to permit 360 degree measurement of radiations.

13. The wearable sensor device of claim 12, wherein at least one of the one or more sensors that measure the infrared radiation or the visible light sensor in combination with the LED and the one or more processors are configured to receive the clinical information data from inputs to the wearable sensor device, based on taps or multiple taps of the wearable sensor device surface or the display screen, continuously touching the wearable sensor device surface or the display screen, or based on the distance of a gesture toward the wearable sensor device surface, and store the data inputs in the memory.

14. The wearable sensor device of claim 12, wherein the display screen is a touch sensitive screen.

15. The wearable sensor device of claim 8, wherein the clinical information data includes five or more of age, gender, skin type or tone, amount of body covered with clothing or photo-protective clothing, disease status, skin status, skin conditions, reactions, when sunscreen was last applied, geographic location, and SPF level of sunscreen last applied.

16. The wearable sensor device of claim 15, wherein the clinical information data further includes current and past medication history, family history of skin sensitivity, tanning bed use, and occupational and recreational activity information.

17. The wearable sensor device of claim 16, further configured and programmed to determine the personalized radiation pattern for an evolution in disease activity, skin aging, and risk level from radiation exposure, based on skin pictures, reported skin symptoms, imaging, laboratory tests, or dermatological tests communicated directly via the wearable sensor device or via remote computing device that is paired with or connected to the wearable sensor device.

18. The wearable sensor device of claim 15, further configured and programmed to track time of radiation exposure, total radiation exposure, and issue alerts to apply sunscreen, limit radiation exposure, and end radiation exposure.

19. The device of claim 17, further configured to track a time of beneficial radiation exposure, and issue alerts that include a time for beneficial radiation exposure.

20. The wearable sensor device of claim 17, further configured and programmed to monitor and determine a personalized radiation pattern to prevent seasonal affective disorder (SAD), nonseasonal depression, and premenstrual dysphoric disorder (PMDD), vitamin D deficiency, based on the clinical information data and data received from the total UV sensor or sensors, the UVA sensor, UVB sensor, the visible light intensity sensor, the IR sensor, and send an alert to the wearable sensor device or to a remote computing device that is paired with or connected to the wearable sensor device or a remote computing device paired with or connected to the wearable sensor device, to obtain sun or light exposure and an amount of time for sun or light exposure.

21. A system for monitoring light intensity and ultraviolet radiation exposure comprising one or more server computers in communication with a wearable sensor device of claim 17, said server computers configured and programmed to receive UV radiation, ambient light data and clinical information data relevant to estimate a personalized radiation pattern for an evolution in disease activity, skin aging, or risk level from radiation exposure of a person wearing the wearable sensor device, including a mobile phone or other computing device that is paired with or connected to the wearable sensor device, convert the UV radiation and the ambient light data, and estimate a personalized evolution in disease activity.

22. A computer based method for monitoring light intensity and ultraviolet radiation exposure comprising:
receiving at one or more server computers clinical information data relevant to estimate a personalized evolution in disease activity, skin aging, or risk level from radiation exposure of a person using a wearable sensor device, at the wearable sensor device or a remote computing device paired with or connected to the wearable sensor device, the wearable sensor device having one or more UV sensors and an ambient light intensity sensor;
storing the clinical information data at the one or more computer servers or on the wearable sensor device;
receiving data corresponding to an amount of UV radiation and ambient light exposure of the wearable sensor device and a time of UV exposure;
integrating at the wearable sensor device or a remote computing device, including a remote computer server paired or connected with the wearable sensor device, the total UV exposure received at the wearable sensor device over the time of UV exposure; electronically calculating a personalized radiation pattern for an evolution in disease activity, skin aging, and risk level from radiation exposure based on the received data from the one or more UV sensors, and ambient light intensity sensor, and the of the user of the wearable sensor device and other users of the wearable sensor device and determining a time for safe UV exposure;
comparing the amount of UV radiation received and the time of UV exposure, and issuing an alert to one or both of the wearable sensor device or a remote computing device paired with or connected to the wearable sensor device; and should providing an alert of a time remaining for safe UV exposure, apply sunscreen or protective outerwear, limit, or stop UV exposure.

23. The method of claim 22, wherein the clinical information data includes five or more of age, gender, skin type or tone, amount of body covered with clothing or photo-protective clothing, disease status, skin status, skin conditions, reactions, when sunscreen was last applied, geographic location, and SPF level of sunscreen last applied.

24. The method of claim 22, the method further comprising the steps of determining a time for beneficial radiation exposure; and issuing an alert on the time remaining for beneficial sun exposure.

25. The method of claim 22, further comprising steps of electronically calculating a minimum radiation exposure to prevent seasonal affective disorder (SAD), nonseasonal depression, and premenstrual dysphoric disorder (PMDD), vitamin D deficiency; and issuing an alert on a time remaining for the minimum light exposure.

26. The method of claim 22, further comprising performing a check on the data received from the total UV sensor or sensors by comparing the received data from the total UV sensor or sensors with the data received at a UVA sensor, UVB and UVC sensor.

27. The method of claim 22, further comprising receiving additional feedback to update clinical information, including sunscreen application and any symptoms experienced since clinical information data was last reported.

28. The method of claim 22, further comprising calculate electronically an appropriate interval for communicating sensor readings from the wearable sensor device to a remote computing device paired with or connected to the wearable sensor device based on the clinical information data.

29. The method of claim 28, wherein the appropriate interval is seconds, minutes, hours, days, or months.
